(19) United States
(12) Patent Application Publication
(10) Pub. No.: US 2026/0311148 A1
(43) Pub. Date: Oct. 8, 2026

(54) UNIFIED DIGITAL PLATFORM FOR LIFECYCLE MANAGEMENT OF NON-FUNGIBLE TOKENS

(71) Applicant: PAYPAL, INC., San Jose, CA (US)

(72) Inventors: Nishanthi Yuvaraj, RoundRock, TX (US); Martin Louis, Liberty Hill, TX (US)

(21) Appl. No.: 19/172,465

(22) Filed: Apr. 7, 2025

(51) Int. Cl. G06Q 20/06; G06F 21/31; G06Q 20/36

(52) U.S. Cl. CPC G06Q 20/065; G06F 21/31; G06Q 20/36; G06Q 2220/00

(57) ABSTRACT

Methods and systems described herein may implement a unified digital platform for lifecycle management of non-fungible tokens (NFTs). An online transaction processor may provide computing services utilized during a lifecycle of NFT ownership including minting, purchase, sale, use of ownership benefits, and the like. The transaction processor may provide a single unified digital platform having a unified login tracked between the different computing services used during NFT lifecycle management. This digital platform may include processes for user to add NFTs to their digital wallets and collections, secure store the NFTs, authenticate and verify the validity and ownership of NFTs, and/or sell NFT on a marketplace including valuing NFTs based on different market factors and dynamics. The digital platform may also provide a single application or other service portal that unifies and limits access points and/or authentications to prevent and/or limit user reauthentication for different NFT usage services.

### TECHNICAL FIELD

The present disclosure generally relates to blockchain technology including non-fungible tokens (NFTs) and hardware and software related thereto. More specifically, the present disclosure relates to systems and methods for implementing a unified NFT platform that enables management of different NFT lifecycles.

### BACKGROUND

Users may utilize online electronic transaction processors to process transactions between end users as well as exchange and transfer funds. This may include transactions at physical merchant locations with real-world merchants, as well as online transactions on digital merchant marketplaces and the like, and transaction may be processed using standardized fiat currency, cryptocurrency, and/or other digital assets including NFTs. For example, with NFTs, users may have purchased or otherwise acquired one or more NFTs (e.g., through a trade, purchase and payment, minting event, etc.), which may be stored by and transferred to and from a digital wallet of the user. Further entities, such as online transaction processors, cryptocurrency and/or NFT trading platforms, merchants, and the like may also use digital wallets to manage cryptocurrency. To facilitate these exchanges and transfers of NFTs, as well as other lifecycle events for NFTs and/or NFT ownership by a user, such as from a minting event or acquisition to a later sale and transfer of ownership (e.g., through an exchange or transfer of private cryptocurrency keys). However, in the current NFT ecosystem, there is not a single platform or application that handles minting, handling, and other lifecycle events through sale or other transfer of ownership. Instead, a user may be required to verify and login to multiple platforms, and may be required to trust each of these platforms with their NFTs and/or private keys for NFT ownership.

For example, due to the artistic and often unique or personalized nature of NFTs, many NFTs are associated with experiences, exclusive owner benefits, and other types of bonuses or incentives provided to the owners of the NFT. Some NFTs may be a single unique collectable or be a limited-edition or series. As such, mere ownership of an NFT may not provide the owner with the benefits of such ownership, and utilizing all of the individual benefits of NFT ownership including asset value tracking and proof of originality typically requires the use of multiple platforms that are often not integrated to provide seamless login, authentication, user and NFT verification or authentication, and the like. As such, there exists a need for a unified platform, marketplace, and experience for NFT ownership that reduces user login events, enables authentication to be tracked for NFTs between services, and limits the exposure of user data and NFT assets, including any private or other cryptographic keys for proof of ownership, to additional sources of fraud and theft. Thus, it is desirable to provide users and entities with a more efficient, coordinated, and secure platform for NFT lifecycle management.

### BRIEF DESCRIPTION OF THE DRAWINGS

The accompanying drawings, which are included to provide further understanding and are incorporated in and constitute a part of this specification, illustrate disclosed embodiments and, together with the description, serve to explain the principles of the disclosed embodiments. In the drawings:

FIG. 1 illustrates an environment of an exemplary computing architecture for facilitating one or more blockchain based transactions, according to an embodiment;

FIG. 2 illustrates an environment of an exemplary blockchain network, according to an embodiment;

FIG. 3 illustrates a block diagram of an exemplary blockchain, according to an embodiment;

FIG. 4 illustrates a block diagram of an exemplary transaction message, according to an embodiment;

FIG. 5 illustrates a block diagram of an exemplary transaction broadcast the blockchain network, according to an embodiment;

FIG. 6A illustrates a flow diagram showing steps of an example method for performing a blockchain based transaction, according to an embodiment;

FIG. 6B illustrates a flow diagram showing steps of an example method for performing a blockchain based transaction, according to an embodiment;

FIG. 7A illustrates an example of a privately broadcasted blockchain, according to an embodiment;

FIG. 7B illustrates an example of blockchain misuse, according to an embodiment;

FIG. 8 illustrates a block diagram of a blockchain enabled in-store purchase system, according to an embodiment;

FIG. 9 illustrates a block diagram of a blockchain enabled in-vehicle purchase system, according to an embodiment;

FIG. 10 illustrates a block diagram of a networked system suitable for implementing the processes described herein, according to an embodiment;

FIGS. 11A and 11B illustrates exemplary system architectures for a unified NFT digital platform for managing lifecycles of NFT ownership, according to an embodiment;

FIGS. 12A and 12B illustrates exemplary diagrams associated with NFT lifecycle management of NFTs using a unified digital platform for inclusion of different NFT services used during lifecycles of NFT ownership, according to an embodiment;

FIG. 13 illustrates a flowchart for a unified digital platform for lifecycle management of NFTs, according to an embodiment; and

FIG. 14 illustrates a block diagram of a computer system suitable for implementing one or more components in FIG. 1, according to an embodiment.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized, and structural and functional modifications may be made, without departing from the scope described herein. Various aspects are capable of other embodiments and of being practiced or being carried out in various different ways.

In its broadest sense, a blockchain refers to a framework that supports a trusted ledger that is stored, maintained, and updated in a distributed manner in a peer-to-peer network. For example, in a cryptocurrency application, such as applications for Bitcoin, Ethereum, Ripple, Dash, Litecoin, Dogecoin, zCash, Tether, Bitcoin Cash, Cardano, Stellar, Monero, and the like, or in digital currency exchanges, such as Coinbase™, Kraken™, and others, the distributed ledger represents each transaction where units of the cryptocurrency are transferred between entities. Using a digital currency exchange, a user may buy any value of digital currency or exchange any holdings in digital currencies into worldwide currency or other digital currencies. Each transaction can be verified by the distributed ledger, and only verified transactions are added to the ledger. The ledger, along with many aspects of blockchain, may be referred to as “decentralized” in that a central authority is typically not present. Because of this, the accuracy and integrity of the ledger cannot be attacked at a single, central location. Modifying the ledger at all, or a majority of, locations where it is stored is made difficult so as to protect the integrity of the ledger. This is due in large part because individuals associated with the nodes that make up the peer-to-peer network have a vested interest in the accuracy of the ledger.

Although maintaining cryptocurrency transactions in the distributed ledger may be the most recognizable use of blockchain technology today, the ledger may be used in a variety of different fields. Indeed, blockchain technology is applicable to any application where data of any type may be accessed where the accuracy of the data is assured. In some embodiments described herein, blockchains may be utilized with unique digital assets and provide a manner in which ownership of the specific digital asset may be uniquely, securely, and provably provided, as well as provide ownership rights to that digital item, which inherently possesses difficulties in ownership due to the ephemeral nature of digital assets versus real assets. Since non-fungible tokens (NFTs) often represent digital items of limited or single creation or issuance, NFTs are not fungible, that is they may not be mutually interchangeable. Instead, NFTs, similar to artwork or other items of creative value, may have large variance in price or prices inexplicable by normal market value and/or dynamics due to their creative expression, artist or creator, and the like. As such, NFTs vary greatly from more fungible assets and may require different services and platforms to handle the various events and uses of NFTs over their lifecycle of ownership by one or more users. However, the current and conventional NFT marketplace merely provides singular services, which each require their own security and user authentication for digital asset access, sale, purchase, use of ownership benefits, and the like. As such, users are burdened with creating multiple logins and performing a new authentication for each service, and further they risk having data necessary to transfer or convey ownership being breached or obtained by a malicious or fraudulent party.

As such, conventional NFT applications and services provide limited functionality generally specifically tied to a service being offered, such as an NFT marketplace, an NFT asset verification platform, and/or an NFT digital wallet or other online vault or storage platform. This is due to the nature of NFTs, which are non-fungible, have varied and unique ownership groups, authors, artists, or creators, and also may have widely varying prices and values that may be subjective and different for different purchasers and sellers. As such, according to various embodiments described herein, a service provider may utilize a single digital platform to provide lifecycle management for NFT ownership, which may include purchase, valuation, proof of originality, source, minting/creation, and the like, usage of ownership benefits, sale, and the like. Such a unified digital platform may be provided for NFT owners or prospective NFT owners, where NFTs may be added to a digital wallet of a user through purchase or onboarding and/or addition from another digital wallet or platform, and users may manage a lifecycle of their use through multiple provided computing services. Lifecycle use may include actions and activities from minting, to possession (if that occurs after minting or other time the NFT is created), and throughout ownership until sale, destruction, use for an end purpose (e.g., if the NFT is “burnt up” or destroyed upon completion of an event, at a time, when an event occurs, etc.), or other divestment of ownership. This may be done through a single login and/or authentication, and users may not be required reauthenticate to access each computing service. Instead, users may have a trusted digital wallet platform to hold their NFTs and other digital assets, and may quickly and conveniently utilize the NFT services with their NFTs and having proof of NFT ownership without risking exposure or theft of their NFTs from use of multiple different platforms, applications, and/or websites.

Online transaction processors, such as PayPal® or Venmo®, may be used to process transactions electronically, which may include transactions involving NFTs and/or where NFTs may be used to convey different types of ownership benefits. In order to provide consolidated NFT ownership services and lifecycle management to users and entities, the transaction processor, in various embodiments, may provide digital wallets and a unified digital platform for NFT lifecycle management that enables users to buy, sell, value, prove originality of, and/or perform other ownership activity. The transaction processor may receive NFTs for a user by receiving NFT ownership certificates, information, private keys, and the like at a wallet address of a digital wallet for the user with the transaction processor. In other embodiments, the transaction processor may provide a digital marketplace where users can buy, sell, and trade NFTs, enabling ownership and addition to the user's digital wallet via purchase. The transaction processor may also provide different computing services for NFT ownership through one or more incorporated applications and/or services.

For electronic transaction processing, digital payments, and NFT ownership services, an online service provider (e.g., an online transaction processor, such as PAYPAL®) may provide account services to users and entities of the online service provider. For individual users, as well as entities including merchants and businesses, a user may establish a digital account and corresponding digital wallet for payment services, as well as NFT ownership services, uses, and benefits. An account with corresponding authentication information may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information.

The entity may be required to provide financial information, including payment card information (e.g., information for a credit/debit card), bank account information, gift card information, benefits/incentives, and/or financial investments. This information may be used to process transactions for items and/or services including purchase, sale, and use of NFTs. In some embodiments, the account creation may establish account funds and/or values, such as by transferring fiat currency, virtual currency, cryptocurrency, and/or NFTs into the account and/or establishing a credit limit and corresponding credit value that is available to the account, for example, to purchase NFTs and/or trade NFTs. This may include loading cryptocurrency and/or NFTs to the account, digital wallet, and/or online cryptocurrency exchange or another platform by sending from another wallet address to a wallet address associated with the account, as well as integrating another digital wallet (e.g., an offline cold wallet and/or wallet on another cryptocurrency exchange platform). The online payment provider may provide digital wallet services, which may offer financial services to send, store, and receive money, process financial instruments, and/or provide transaction histories, including tokenization of digital wallet data for transaction processing. The application or website of the service provider, such as PAYPAL® or other online payment provider, may provide payments and other transaction processing services. Once the account of the user is established with the service provider, the user may utilize the account via one or more computing devices, such as a personal computer, tablet computer, mobile smart phone, or the like.

A user may utilize cryptocurrency and NFTs and a digital cryptocurrency/NFT wallet to process payments, trade, exchange, or otherwise change ownership of NFTs through a blockchain and digital wallet address. For example, a user may process a transaction for digital assets including NFTs between digital wallets, nodes, or users, which transfers ownership of the cryptocurrency or NFT. When persisting the transaction to a digital ledger associated with the blockchain and corresponding blockchain protocol, miners may be used to verify the transaction, broadcast on the network, and cause the transaction to be recorded in a block on the corresponding blockchain. For example, with a cryptocurrency such as Bitcoin, transactions and Bitcoin transfers require resolution by updating blocks in a distributed ledger on a distributed blockchain network over many computing devices, nodes, servers, and the like. Each block may refer to a ledger record or block that is designed to record the transaction on the distributed ledger for proof of the transactions. Miners may be used to verify and record the individual blocks on the blockchain, which requires time, computing resources, and network bandwidth to broadcast and verify the transactions on recipient nodes after computing some value, such as a nonce. Thus, each block requires a proof of work, which is used to verify and accept each block on the blockchain network. Similar processes may be used with other blockchains and corresponding cryptocurrencies, NFTs, and the like, such as to record NFT ownership and/or changes of ownership, as well as other NFT information including value, corresponding artwork or digital asset, and the like.

Where the transaction processor provides a unified and single (or integrated components that can be served from one centralized application hub) digital platform for NFT lifecycle maintenance, the transaction processor may provide a single login and authentication process and requirement, thereby minimizing the number of logins and authentications required by users and streamlining the processes for NFT purchase, sale, and/or ownership usage of benefits. This may further include the transaction processor providing the unified digital platform for NFT lifecycle management through a single application or suite of applications, or website with corresponding webpages or multiple websites incorporated in a larger domain of websites known, cross-linked, and made available to users. As such, initially a user may set up an account and/or establish NFTs with a digital account, and may engage with the unified digital platform. This may include logging in to the account on the digital platform through a website or a native software application. Once access to the account has been verified and the user authenticated using login information and the like, the user may access their digital wallet and/or engage in the computing services used for or with NFTs including a digital marketplace, a checkout and/or payments platform to pay for transactions with NFTs, a donation or charity platform, an ownership rewards and offers platform, and/or a blockchain platform that may include or utilize an NFT authentication and verification platform.

After performing a universal login for the different computing services associated with NFT usage that the digital platform offers, the user may be presented with a user interface for their digital wallet, where the user may view their owned NFTs, any wish list or tracking of other NFTs, and/or may perform other actions for NFT ownership. For example, the digital wallet may be integrated with a blockchain platform that may perform minting of NFTs, as well as buying and selling of NFTs using a cryptocurrency and/or NFT digital exchange. The user may authenticate tokens for NFT ownership (e.g., digital certificates transferrable for the rights to the NFT), and may verify NFT ownership, that their ownership is valid, and/or that the NFT is valid and corresponds to the purported token, linked copyrighted work, or the like. As such, the user may establish an authenticity of the NFT, which may be based on the NET's information, lifecycle, and/or other available information for the NFT's blockchain or other NFTs that may be associated with or related to the NFT being validated.

The user may also engage in other processes for NFT usage including checkout and payment processing where one or more transaction may be made using NFTs, and loyalty and offers may be specifically targeted to the user based on the owned or desired NFTs. For example, certain NFTs may provide a discount to owners for the purchase of certain products, services, memberships, and the like. Other users may be interested in purchasing similar products to the NFTs that they own. This checkout process and/or service for the NFT digital platform may also be associated with a donation platform, where NFTs, or their sale/purchase, may be donated to a specific charity, charitable activity, limited edition auction, or the like. A rewards and/or offers computing service may provide NFT coupons to be applied to transactions and/or used when purchasing items. Further, the rewards service may tie together all of the user's ownership benefits from different NFT ownership into a single service and place where the user may view their benefits including discounts, reward points or services, events, and the like.

As such, the unified digital platform may provide a single application, website, or the like where a user may perform many of the different lifecycle NFT ownership activities, events, and processes through multiple integrated computing services. This allows users to utilize a single universal login to access their NFTs that are secured with a trusted service provider instead of distributed over many different providers and platforms that inherently risk additional exposure to theft and fraud. Further, the unified platform allows for faster, more efficient, and more trusted NFT verification, as well as valuation and trade or exchange. In this manner, the transaction processor may enable users and entities to conduct NFT transactions more efficiently, faster, and in a more secure manner than the conventional use of multiple different platforms and providers that limid NFT computing services to small set of activities. As such, the unified digital platform described herein provides a scope to NFT ownership usage not possible through conventional blockchain technologies. This further improves the blockchain and NFT protocols by providing a more trusted and easily verifiable source of data when writing to their blockchain and/or verifying blockchain records.

Implementations of the present disclosure will now be described in detail with reference to the accompanying Figures. It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

### Computing Architecture

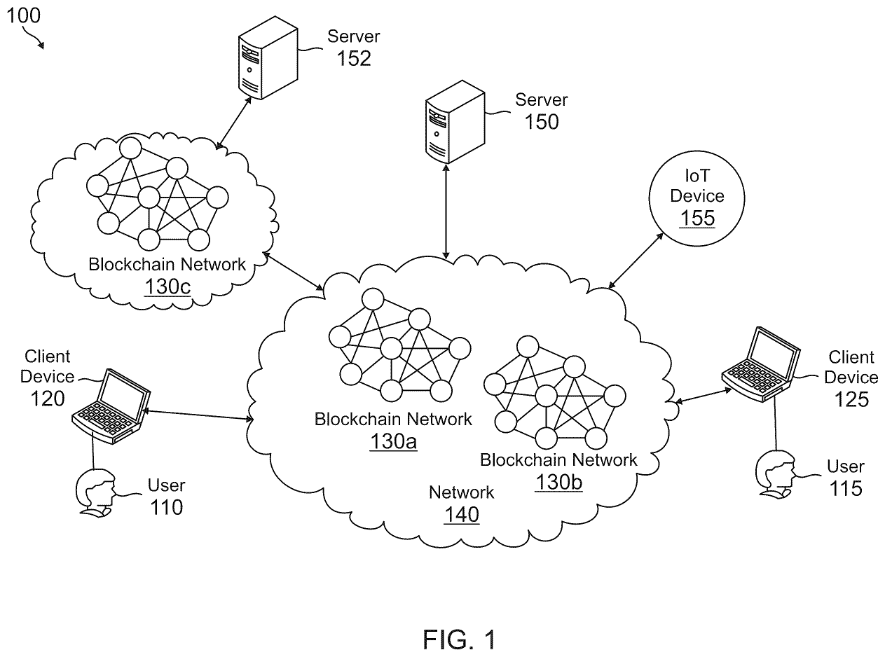

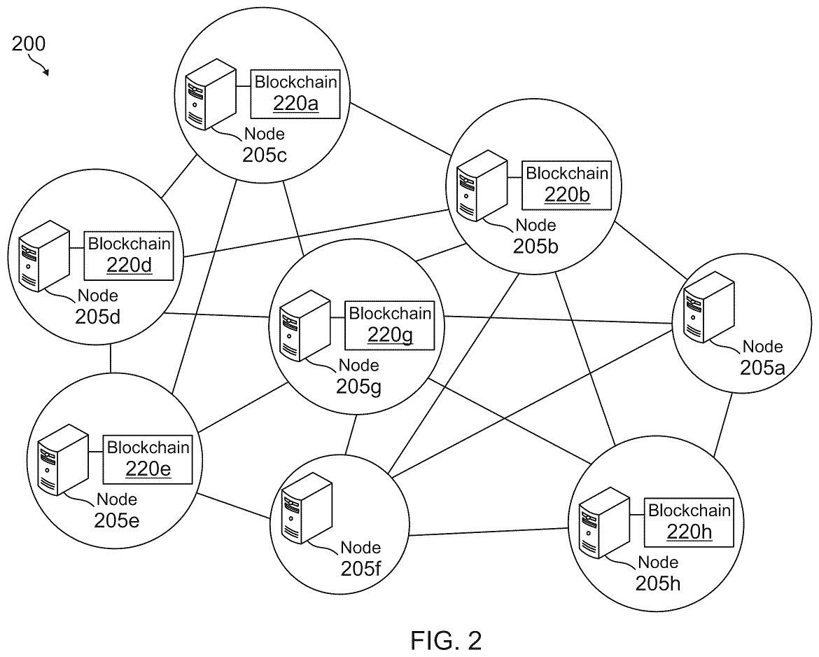

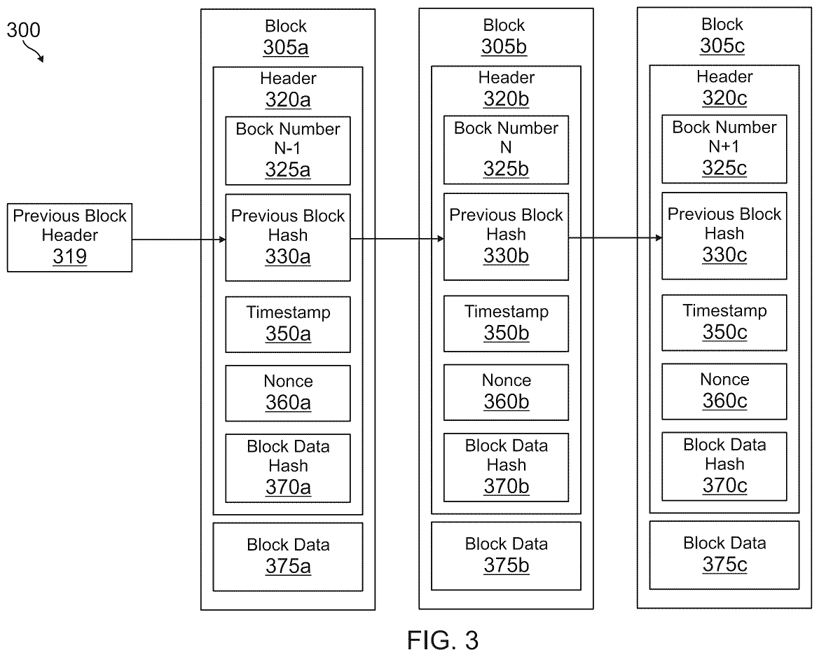

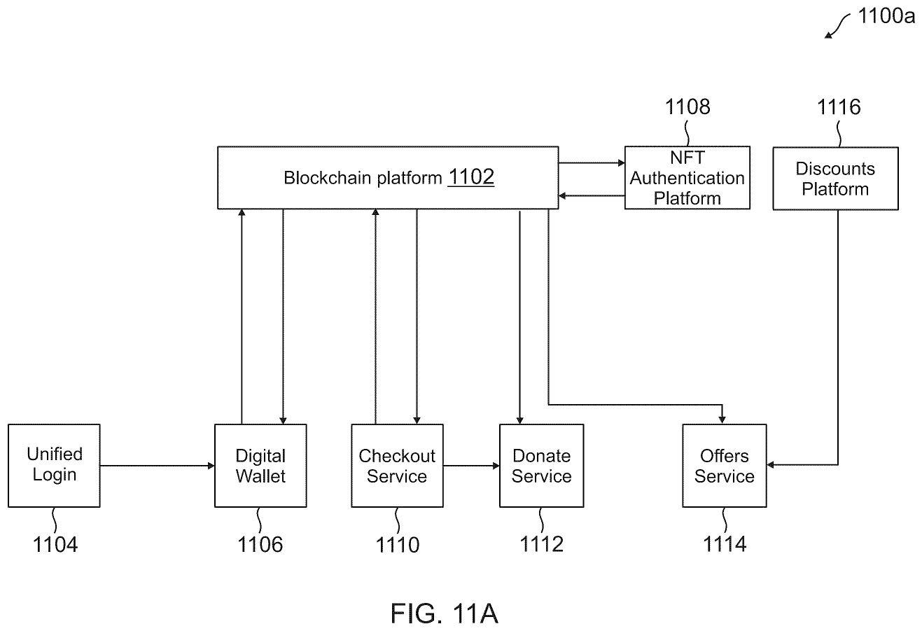

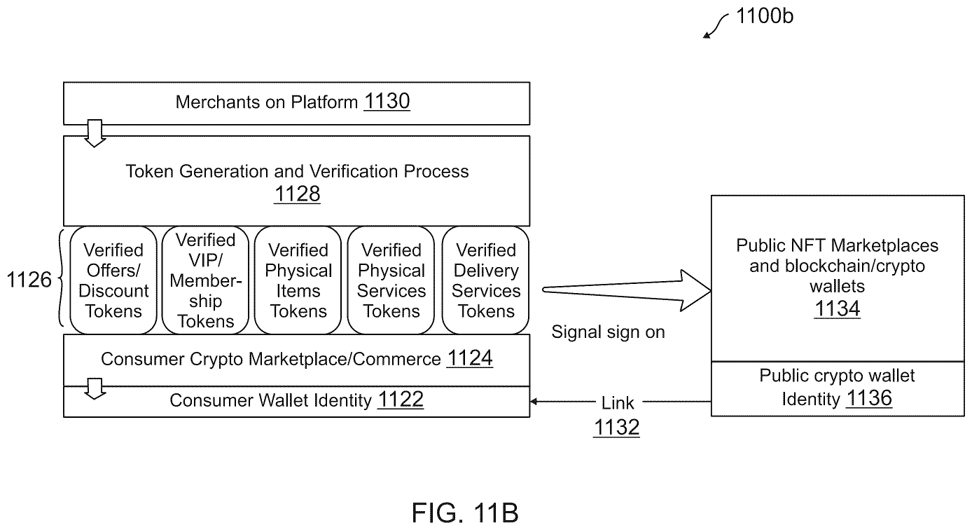

As discussed above, the distributed ledger in a blockchain framework is stored, maintained, and updated in a peer-to-peer network. In one example the distributed ledger maintains a number of blockchain transactions. FIG. 1 shows an example system 100 for facilitating a blockchain transaction. The system 100 includes a first client device 120, a second client device 125, a first server 150, a second server 152, and an Internet of Things (IOT) device 155 interconnected via a network 1050. The first client device 120, the second client device 125, the first server 150, and/or the second server 152 may be a computing device 1105 described in more detail with reference to FIG. 11. The IoT device 155 may comprise any of a variety of devices including vehicles, home appliances, embedded electronics, software, sensors, actuators, thermostats, light bulbs, door locks, refrigerators, RFID implants, RFID tags, pacemakers, wearable devices, smart home devices, cameras, trackers, pumps, POS devices, and stationary and mobile communication devices along with connectivity hardware configured to connect and exchange data. The network 1050 may be any of a variety of available networks, such as the Internet, and represents a worldwide collection of networks and gateways to support communications between devices connected to the network 1050. The system 100 may also comprise one or more distributed or peer-to-peer (P2P) networks, such as a first, second, and third blockchain networks 130a-c (generally referred to as blockchain networks 130). As shown in FIG. 1, the network 1050 may comprise the first and second blockchain networks 130a and 130b. The third blockchain network 130c may be associated with a private blockchain as described below with reference to FIG. 2 and is connected to one or more servers, such as the server 152, and is thus, shown separately from the first and second blockchain networks 130a and 103b. Each blockchain network 130 may comprise a plurality of interconnected devices (or nodes) as described in more detail with reference to FIG. 2. As discussed above, a ledger, or blockchain, is a distributed database for maintaining a growing list of records comprising any type of information. A blockchain, as described in more detail with reference to FIG. 3, may be stored at least at multiple nodes (or devices) of the one or more blockchain networks 130.

In one example, a blockchain based transaction may generally involve a transfer of data or value between entities, such as the first user 110 of the first client device 120 and the second user 115 of the second client device 125 in FIG. 1. Each of the servers 150 and 152 may include one or more applications, for example, a transaction application configured to facilitate the transaction between the entities by utilizing a blockchain associated with one of the blockchain networks 130. As an example, the first user 110 may request or initiate a transaction with the second user 115 via a user application executing on the first client device 120. The transaction may be related to a transfer of value or data from the first user 110 to the second user 115. The first client device 120 may send a request of the transaction to the server 150. The first server 150 and/or the second server 152 may send the requested transaction to one of the blockchain networks 130 to be validated and approved as discussed below.

Blockchain Network FIG. 2 shows an example blockchain network 200 comprising a plurality of interconnected nodes or devices 205a-h (generally referred to as nodes 205). Each of the nodes 205 may comprise a computing device 1105 described in more detail with reference to FIG. 11. Although FIG. 2 shows a single device 205, each of the nodes 205 may comprise a plurality of devices (e.g., a pool). The blockchain network 200 may be associated with one or more blockchains 220a-h (generally referred to as blockchain 220). Some or all of the nodes 205 may replicate and save an identical copy of the blockchain 220. For example, FIG. 3 shows that the nodes 205b-e and 205g-h store copies of the blockchain 220. The nodes 205b-e and 205g-h may independently update their respective copies of the blockchain 220 as discussed below.

### Blockchain Node Types

Blockchain nodes, for example, the nodes 205, may be full nodes or lightweight nodes. Full nodes, such as the nodes 205b-e and 205g-h, may act as a server in the blockchain network 200 by storing a copy of the entire blockchain 220 and ensuring that transactions posted to the blockchain 220 are valid. The full nodes 205b-e and 205g-h may publish new blocks on the blockchain 220. Lightweight nodes, such as the nodes 205a and 205f, may have fewer computing resources than full nodes. For example, IoT devices often act as lightweight nodes. The lightweight nodes may communicate with other nodes 205, provide the full nodes 205b-e and 205g-h with information, and query the status of a block of the blockchain 220 stored by the full nodes 205b-e and 205g-h. In this example, however, as shown in FIG. 2, the lightweight nodes 205a and 205f may not store a copy of the blockchain 220 and thus, may not publish new blocks on the blockchain 220.

### Blockchain Network Types

The blockchain network 200 and its associated blockchain 220 may be public (permissionless), federated or consortium, or private. If the blockchain network 200 is public, then any entity may read and write to the associated blockchain 220. However, the blockchain network 200 and its associated blockchain 220 may be federated or consortium if controlled by a single entity or organization. Further, any of the nodes 205 with access to the Internet may be restricted from participating in the verification of transactions on the blockchain 220. The blockchain network 200 and its associated blockchain 220 may be private (permissioned) if access to the blockchain network 200 and the blockchain 220 is restricted to specific authorized entities, for example organizations or groups of individuals. Moreover, read permissions for the blockchain 220 may be public or restricted while write permissions may be restricted to a controlling or authorized entity.

### Blockchain

As discussed above, a blockchain 220 may be associated with a blockchain network 200. FIG. 3 shows an example blockchain 300. The blockchain 300 may comprise a plurality of blocks 305a, 305b, and 305c (generally referred to as blocks 305). The blockchain 300 comprises a first block (not shown), sometimes referred to as the genesis block. Each of the blocks 305 may comprise a record of one or a plurality of submitted and validated transactions. The blocks 305 of the blockchain 300 may be linked together and cryptographically secured. In some cases, the post-quantum cryptographic algorithms that dynamically vary over time may be utilized to mitigate ability of quantum computing to break present cryptographic schemes. Examples of the various types of data fields stored in a blockchain block are provided below. A copy of the blockchain 300 may be stored locally, in the cloud, on grid, for example by the nodes 205b-e and 205g-h, as a file or in a database.

### Blocks

Each of the blocks 305 may comprise one or more data fields. The organization of the blocks 305 within the blockchain 300 and the corresponding data fields may be implementation specific. As an example, the blocks 305 may comprise a respective header 320a, 320b, and 320c (generally referred to as headers 320) and block data 375a, 375b, and 375c (generally referred to as block data 375). The headers 320 may comprise metadata associated with their respective blocks 305. For example, the headers 320 may comprise a respective block number 325a, 325b, and 325c. As shown in FIG. 3, the block number 325a of the block 305a is N-1, the block number 325b of the block 305b is N, and the block number 325c of the block 305c is N+1. The headers 320 of the blocks 305 may include a data field comprising a block size (not shown).

The blocks 305 may be linked together and cryptographically secured. For example, the header 320b of the block N (block 305b) includes a data field (previous block hash 330b) comprising a hash representation of the previous block N-1's header 320a. The hashing algorithm utilized for generating the hash representation may be, for example, a secure hashing algorithm 256 (SHA-256) which results in an output of a fixed length. In this example, the hashing algorithm is a one-way hash function, where it is computationally difficult to determine the input to the hash function based on the output of the hash function. Additionally, the header 320c of the block N+1 (block 305c) includes a data field (previous block hash 330c) comprising a hash representation of block N's (block 305b) header 320b.

The headers 320 of the blocks 305 may also include data fields comprising a hash representation of the block data, such as the block data hash 370a-c. The block data hash 370a-c may be generated, for example, by a Merkle tree and by storing the hash or by using a hash that is based on all of the block data. The headers 320 of the blocks 305 may comprise a respective nonce 360a, 360b, and 360c. In some implementations, the value of the nonce 360a-c is an arbitrary string that is concatenated with (or appended to) the hash of the block. The headers 320 may comprise other data, such as a difficulty target.

The blocks 305 may comprise a respective block data 375a, 375b, and 375c (generally referred to as block data 375). The block data 375 may comprise a record of validated transactions that have also been integrated into the blockchain 200 via a consensus model (described below). As discussed above, the block data 375 may include a variety of different types of data in addition to validated transactions. Block data 375 may include any data, such as text, audio, video, image, or file, that may be represented digitally and stored electronically.

### Blockchain Transaction

In one example, a blockchain based transaction may generally involve a transfer of data or value or an interaction between entities and described in more detail below. Referring back to FIG. 1, the first server 150 and/or the second server 152 may include one or more applications, for example, a transaction application configured to facilitate a blockchain transaction between entities. The entities may include users, devices, etc. The first user 110 may request or initiate a transaction with the second user 115 via a user application executing on the first client device 120. The transaction may be related to a transfer of value or data from the first user 110 to the second user 115. The value or data may represent money, a contract, property, records, rights, status, supply, demand, alarm, trigger, or any other asset that may be represented in digital form. The transaction may represent an interaction between the first user 110 and the second user 115.

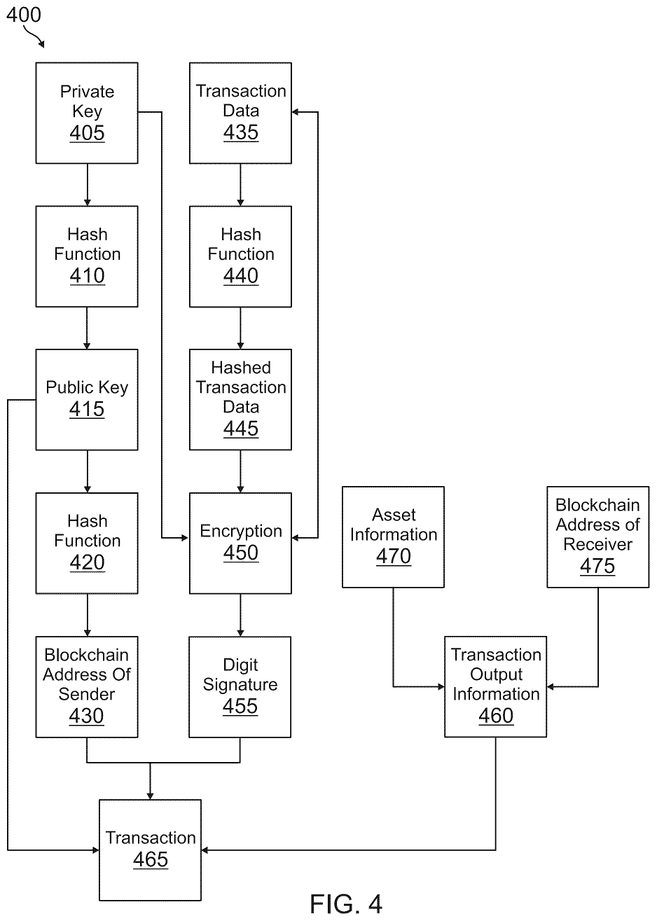

FIG. 4 is a diagram of a transaction 465 generated by the transaction application. The transaction 465 may include a public key 415, a blockchain address 430 associated with the first user 110, a digital signature 455, and transaction output information 460. The transaction application may derive a public key 415 from a private key 405 of the first user 110 by applying a cryptographic hash function 410 to the private key 405. The cryptographic hash function 410 may be based on AES, SHA-2, SHA-3, RSA, ECDSA, ECDH (elliptic curve cryptography), or DSA (finite field cryptography), although other cryptographic models may be utilized. More information about cryptographic algorithms may be found in Federal Information Processing Standards Publication (FIPS PUB 180-3), Secure Hash Standard. The transaction application may derive an address or identifier for the first user 110, such as the blockchain address 430, by applying a hash function 420 to the public key 415. Briefly, a hash function is a function that may be used for mapping arbitrary size data to fixed size data. The value may also be referred to as a digest, a hash value, a hash code, or a hash. In order to indicate that the first user 110 is the originator of the transaction 465, the transaction application may generate the digital signature 455 for the transaction data 435 using the private key 405 of the first user 110. The transaction data 435 may include information about the assets to be transferred and a reference to the sources of the assets, such as previous transactions in which the assets were transferred to the first user 110 or an identification of events that originated the assets. Generating the digital signature 455 may include applying a hash function 440 to the transaction data 435 resulting in hashed transaction data 445. The hashed transaction data 445 and the transaction data 435 may be encrypted (via an encryption function 450) using the private key 405 of the first user 110 resulting in the digital signature 455. The transaction output information 460 may include asset information 470 and an address or identifier for the second user 115, such as the blockchain address 475. The transaction 465 may be sent from the first client device 120 to the first server 150.

The specific type of cryptographic algorithm being utilized may vary dynamically based on various factors, such as a length of time, privacy concerns, etc. For example, the type of cryptographic algorithm being utilized may be changed yearly, weekly, daily, etc. The type of algorithms may also change based on varying levels of privacy. For example, an owner of content may implement a higher level of protection or privacy by utilizing a stronger algorithm.

### Blockchain Addresses

A blockchain network may utilize blockchain addresses to indicate an entity using the blockchain or start and end points in the transaction. For example, a blockchain address for the first user 110, shown in FIG. 4 as the blockchain address of sender 430, may include an alphanumeric string of characters derived from the public key 415 of the first user 110 based on applying a cryptographic hash function 420 to the public key 415. The methods used for deriving the addresses may vary and may be specific to the implementation of the blockchain network. In some examples, a blockchain address may be converted into a QR code representation, barcode, token, or other visual representations or graphical depictions to enable the address to be optically scanned by a mobile device, wearables, sensors, cameras, etc. In addition to an address or QR code, there are many ways of identifying individuals, objects, etc. represented in a blockchain. For example, an individual may be identified through biometric information such as a fingerprint, retinal scan, voice, facial id, temperature, heart rate, gestures/movements unique to a person etc., and through other types of identification information such as account numbers, home address, social security number, formal name, etc.

### Broadcasting Transaction

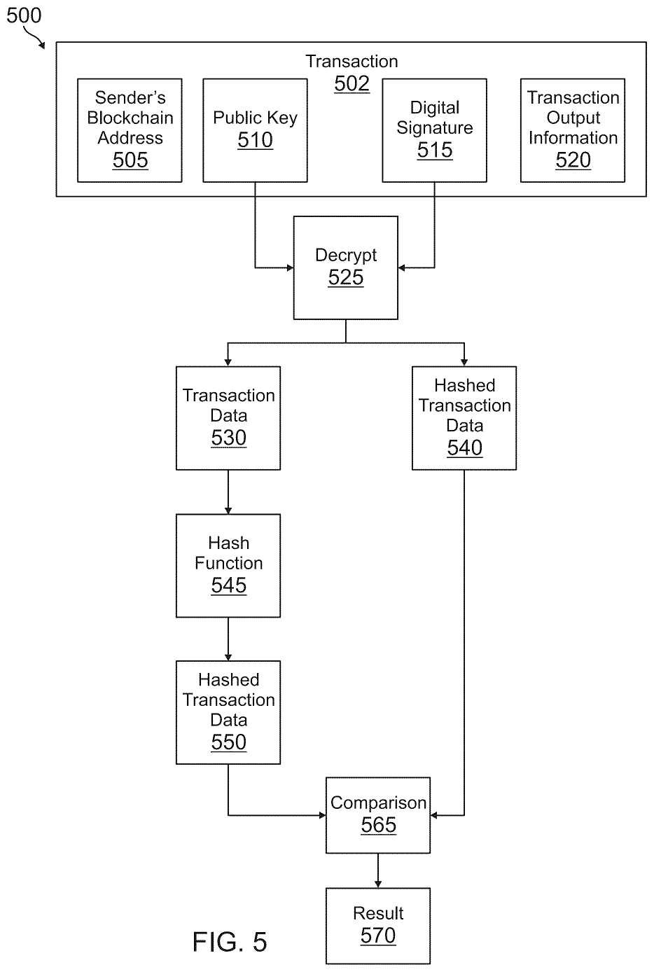

The first server 150 may receive transactions from users of the blockchain network 130. The transactions may be submitted to the first server 150 via desktop applications, smartphone applications, digital wallet applications, web services, or other software applications. The first server 150 may send or broadcast the transactions to the blockchain network 130. FIG. 5 shows an example transaction 502 broadcast by the server 150 to the blockchain network 130. The transaction 502 may be broadcast to multiple nodes 205 of the blockchain network 130. Typically, once the transaction 502 is broadcast or submitted to the blockchain network 130, it may be received by one or more of the nodes 205. Once the transaction 502 is received by the one or more nodes 205 of the blockchain network 130, it may be propagated by the receiving nodes 205 to other nodes 205 of the blockchain network 130.

A blockchain network may operate according to a set of rules. The rules may specify conditions under which a node may accept a transaction, a type of transaction that a node may accept, a type of compensation that a node receives for accepting and processing a transaction, etc. For example, a node may accept a transaction based on a transaction history, reputation, computational resources, relationships with service providers, etc. The rules may specify conditions for broadcasting a transaction to a node. For example, a transaction may be broadcasted to one or more specific nodes based on criteria related to the node's geography, history, reputation, market conditions, docket/delay, technology platform. The rules may be dynamically modified or updated (e.g., turned on or off) to address issues such as latency, scalability and security conditions. A transaction may be broadcast to a subset of nodes as a form of compensation to entities associated with those nodes (e.g., through receipt of compensation for adding a block of one or more transactions to a blockchain).

### Transaction Validation—User Authentication and Transaction Data Integrity

Not all the full nodes 205 may receive the broadcasted transaction 502 at the same time, due to issues such as latency. Additionally, not all of the full nodes 205 that receive the broadcasted transaction 502 may choose to validate the transaction 502. A node 205 may choose to validate specific transactions, for example, based on transaction fees associated with the transaction 502. The transaction 502 may include a blockchain address 505 for the sender, a public key 510, a digital signature 515, and transaction output information 520. The node 205 may verify whether the transaction 502 is legal or conforms to a pre-defined set of rules. The node 205 may also validate the transaction 502 based on establishing user authenticity and transaction data integrity. User authenticity may be established by determining whether the sender indicated by the transaction 502 is in fact the actual originator of the transaction 502. User authenticity may be proven via cryptography, for example, asymmetric-key cryptography using a pair of keys, such as a public key and a private key. Additional factors may be considered when establishing user authenticity, such as user reputation, market conditions, history, transaction speed, etc. Data integrity of the transaction 502 may be established by determining whether the data associated with the transaction 502 was modified in any way. Referring back to FIG. 4, when the transaction application creates the transaction 465, it may indicate that the first user 110 is the originator of the transaction 465 by including the digital signature 455.

The node 205 may decrypt the digital signature 515 using the public key 510. A result of the decryption may include hashed transaction data 540 and transaction data 530. The node 205 may generate hashed transaction data 550 based on applying a hash function 545 to the transaction data 530. The node 205 may perform a comparison 565 between the first hashed transaction data 540 and the second hashed transaction data 550. If the result 570 of the comparison 565 indicates a match, then the data integrity of the transaction 502 may be established and node 205 may indicate that the transaction 502 has been successfully validated. Otherwise, the data of the transaction 502 may have been modified in some manner and the node 205 may indicate that the transaction 502 has not been successfully validated.

Each full node 205 may build its own block and add validated transactions to that block. Thus, the blocks of different full nodes 205 may comprise different validated transactions. As an example, a full node 205a may create a first block comprising transactions “A,” “B,” and “C.” Another full node 205b may create a second block comprising transactions “C,” “D,” and “E.” Both blocks may include valid transactions. However, only one block may get added to the blockchain, otherwise the transactions that the blocks may have in common, such as transaction “C” may be recorded twice leading to issues such as double-spending when a transaction is executed twice. One problem that may be seen with the above example is that transactions “C,” “D,” and “E” may be overly delayed in being added to the blockchain. This may be addressed a number of different ways as discussed below.

### Securing Keys

Private keys, public keys, and addresses may be managed and secured using software, such as a digital wallet. Private keys may also be stored and secured using hardware. The digital wallet may also enable the user to conduct transactions and manage the balance. The digital wallet may be stored or maintained online or offline, and in software or hardware or both hardware and software. Without the public/private keys, a user has no way to prove ownership of assets. Additionally, anyone with access a user's public/private keys may access the user's assets. While the assets may be recorded on the blockchain, the user may not be able to access them without the private key.

### Tokens

A token may refer to an entry in the blockchain that belongs to a blockchain address. The entry may comprise information indicating ownership of an asset. The token may represent money, a contract, property, records, access rights, status, supply, demand, alarm, trigger, reputation, ticket, or any other asset that may be represented in digital form. For example, a token may refer to an entry related to cryptocurrency that is used for a specific purpose or may represent ownership of a real-world asset, such as Fiat currency or real-estate. Token contracts refer to cryptographic tokens that represent a set of rules that are encoded in a smart contract. The person that owns the private key corresponding to the blockchain address may access the tokens at the address. Thus, the blockchain address may represent an identity of the person that owns the tokens. Only the owner of the blockchain address may send the token to another person. The tokens may be accessible to the owner via the owner's wallet. The owner of a token may send or transfer the token to a user via a blockchain transaction. For example, the owner may sign the transaction corresponding to the transfer of the token with the private key. When the token is received by the user, the token may be recorded in the blockchain at the blockchain address of the user.

### Establishing User Identity

While a digital signature may provide a link between a transaction and an owner of assets being transferred, it may not provide a link to the real identity of the owner. In some cases, the real identity of the owner of the public key corresponding to the digital signature may need to be established. The real identity of an owner of a public key may be verified, for example, based on biometric data, passwords, personal information, etc. Biometric data may comprise any physically identifying information such as fingerprints, face and eye images, voice sample, DNA, human movement, gestures, gait, expressions, heart rate characteristics, temperature, etc.

### Publishing and Validating a Block

As discussed above, full nodes 205 may each build their own blocks that include different transactions. A node may build a block by adding validated transactions to the block until the block reaches a certain size that may be specified by the blockchain rules. However, only one of the blocks may be added to the blockchain. The block to be added to the blockchain and the ordering of the blocks may be determined based on a consensus model. In a proof of work model, both nodes may compete to add their respective block to the blockchain by solving a complex mathematical puzzle. For example, such a puzzle may include determining a nonce, as discussed above, such that a hash (using a predetermined hashing algorithm) of the block to be added to the blockchain (including the nonce) has a value that meets a range limitation. If both nodes solve the puzzle at the same time, then a “fork” may be created. When a full node 205 solves the puzzle, it may publish its block to be validated by the validation nodes 205 of the blockchain network 130.

In a proof of work consensus model, a node validates a transaction, for example, by running a check or search through the current ledger stored in the blockchain. The node will create a new block for the blockchain that will include the data for one or more validated transactions (see, e.g., block 375 of FIG. 3). In a blockchain implementation such as Bitcoin, the size of a block is constrained. Referring back to FIG. 3, in this example, the block will include a Previous Block Hash 330 representing a hash of what is currently the last block in the blockchain. The block may also include a hash 370 of its own transaction data (e.g., a so-called Merkle hash). According to a particular algorithm, all or selected data from the block may be hashed to create a final hash value. According to an embodiment of the proof of work model, the node will seek to modify the data of the block so that the final hash value is less than a preset value. This is achieved through addition of a data value referred to as a nonce 360. Because final hash values cannot be predicted based on its input, it is not possible to estimate an appropriate value for the nonce 360 that will result in a final hash value that is less than the pre-set value. Accordingly, in this embodiment, a computationally-intensive operation is needed at the node to determine an appropriate nonce value through a “brute force” trial-and-error method. Once a successful nonce value is determined, the completed block is published to the blockchain network for validation. If validated by a majority of the nodes in the blockchain network, the completed block is added to the blockchain at each participating node. When a node's block is not added to the blockchain, the block is discarded and the node proceeds to build a new block. The transactions that were in the discarded block may be returned to a queue and wait to be added to a next block. When a transaction is discarded or returned to the queue, the assets associated with the discarded transaction are not lost, since a record of the assets will exist in the blockchain. However, when a transaction is returned to the queue, it causes a delay in completing the transaction. Reducing the time to complete a transaction may be important. A set of blockchain rules, or renumeration/compensation for a node to process the returned transaction may determine how a returned transaction is to be treated going forward. When a transaction is put into a pool then it can have a priority level but then a rule may indicate that the transaction priority level must exceed a threshold level. The priority level of a returned or discarded transaction may be increased. Another way to reduce the time to complete a transaction is to have the system, service provider, participant in the transaction, or merchant pay additional incentive for nodes to process a returned transaction. As an example, a service provider may identify a network of preferred miners based on geography or based on a volume discount perspective. The time to complete a transaction may be optimized by routing a returned transaction to specific preferred nodes. A transaction may be associated with an address that limits which of the preferred nodes will get to process the transaction if it is returned due to its inclusion in a discarded block. A value may be associated with the transaction so that it goes to preferred miners in a specific geographic location. Additionally, returned transactions may be processed based on pre-set rules. For example, a rule may indicate a commitment to process a specific number of returned transactions to receive additional incentive or compensation.

### Blockchain Confirmations

After a block comprising a transaction is added to a blockchain, a blockchain confirmation may be generated for the transaction. The blockchain confirmation may be a number of blocks added to the blockchain after the block that includes the transaction. For example, when a transaction is broadcasted to the blockchain, there will be no blockchain confirmations associated with the transaction. If the transaction is not validated, then the block comprising the transaction will not be added to the blockchain and the transaction will continue to have no blockchain confirmations associated with it. However, if a block comprising the transaction is validated, then each of the transactions in the block will have a blockchain confirmation associated with the transaction. Thus, a transaction in a block will have one blockchain confirmation associated with it when the block is validated. When the block is added to the blockchain, each of the transactions in the block will have two blockchain confirmations associated with it. As additional validated blocks are added to the blockchain, the number of blockchain confirmations associated with the block will increase. Thus, the number of blockchain confirmations associated with a transaction may indicate a difficulty of overwriting or reversing the transaction. A higher valued transaction may require a larger number of blockchain confirmations before the transaction is executed.

### Consensus Models

As discussed above, a blockchain network may determine which of the full nodes 205 publishes a next block to the blockchain. In a permissionless blockchain network, the nodes 205 may compete to determine which one publishes the next block. A node 205 may be selected to publish its block as the next block in the blockchain based on consensus model. For example, the selected or winning node 205 may receive a reward, such as a transaction fee, for publishing its block, for example. Various consensus models may be used, for example, a proof of work model, a proof of stake model, a delegated proof of stake model, a round robin model, proof of authority or proof of identity model, and proof of elapsed time model.

In a proof of work model, a node may publish the next block by being the first to solve a computationally intensive mathematical problem (e.g., the mathematical puzzle described above). The solution serves as “proof” that the node expended an appropriate amount of effort in order to publish the block. The solution may be validated by the full nodes before the block is accepted. The proof of work model, however, may be vulnerable to a 51% attack described below. The proof of stake model is generally less computationally intensive than the proof of work model. Unlike the proof of work model which is open to any node having the computational resources for solving the mathematical problem, the proof of stake model is open to any node that has a stake in the system. The stake may be an amount of cryptocurrency that the blockchain network node (user) may have invested into the system. The likelihood of a node publishing the next block may be proportional to its stake. Since this model utilizes fewer resources, the blockchain may forego a reward as incentive for publishing the next block. The round robin model is generally used by permissioned blockchain networks. Using this model, nodes may take turns to publish new blocks. In the proof of elapsed time model, each publishing node requests a wait time from a secure hardware within their computer system. The publishing node may become idle for the duration of the wait time and then creates and publishes a block to the blockchain network. As an example, in cases where there is a need for speed and/or scalability (e.g. in the context of a corporate environment), a hybrid blockchain network may switch to be between completely or partially permissioned and permissionless. The network may switch based on various factors, such as latency, security, market conditions, etc.

### Forks

As discussed above, consensus models may be utilized for determining an order of events on a blockchain, such as which node gets to add the next block and which node's transaction gets verified first. When there is a conflict related to the ordering of events, the result may be a fork in the blockchain. A fork may cause two versions of the blockchain to exist simultaneously. Consensus methods generally resolve conflicts related to the ordering of events and thus, prevent forks from occurring. In some cases, a fork may be unavoidable. For example, with a proof of work consensus model, only one of the nodes competing to solve a puzzle may win by solving its puzzle first. The winning node's block is then validated by the network. If the winning node's block is successfully validated by the network, then it will be the next block added to the blockchain. However, it may be the case that two nodes may end up solving their respective puzzles at the same time. In such a scenario, the blocks of both winning nodes may be broadcasted to the network. Since different nodes may receive notifications of a different winning node, the nodes that receive notification of the first node as the winning node may add the first node's block to their copy of the blockchain. Nodes that receive notification of the second node as the winning node may add the second node's block to their copy of the blockchain. This results in two versions of the blockchain or a fork. This type of fork may be resolved by the longest chain rule of the proof of work consensus model. According to the longest chain rule, if two versions of the blockchain exist, then the network the chain with a larger number of blocks may be considered to be the valid blockchain. The other version of the blockchain may be considered as invalid and discarded or orphaned. Since the blocks created by different nodes may include different transactions, a fork may result in a transaction being included in one version of the blockchain and not the other. The transactions that are in a block of a discarded blockchain may be returned to a queue and wait to be added to a next block.

In some cases, forks may result from changes related to the blockchain implementation, for example, changes to the blockchain protocols and/or software. Forks may be more disruptive for permissionless and globally distributed blockchain networks than for private blockchain networks due to their impact on a larger number of users. A change or update to the blockchain implementation that is backwards compatible may result in a soft fork. When there is a soft fork, some nodes may execute the update blockchain implementation while other nodes may not. However, nodes that do not update to the new blockchain implementation may continue to transact with updated nodes.

A change to the blockchain implementation that is not backwards compatible may result in a hard fork. While hard forks are generally intentional, they may also be caused by unintentional software bugs/errors. In such a case, all publishing nodes in the network may need to update to the new blockchain implementation. While publishing nodes that do not update to the new blockchain implementation may continue to publish blocks according to the previous blockchain implementation, these publishing nodes may reject blocks created based on the new blockchain implementation and continue to accept blocks created based on the previous blockchain implementation. Therefore, nodes on different hard fork versions of the blockchain may not be able to interact with one another. If all nodes move to the new blockchain implementation, then the previous version may be discarded or abandoned. However, it may not be practical or feasible to update all nodes in the network to a new blockchain implementation, for example, if the update invalidates specialized hardware utilized by some nodes.

### Blockchain-Based Application: Cryptocurrency

Cryptocurrency is a medium of exchange that may be created and stored electronically in a blockchain, such as a the blockchain 130a in FIG. 1. Bitcoin is one example of cryptocurrency, however there are several other cryptocurrencies. Various encryption techniques may be used for creating the units of cryptocurrency and verifying transactions. As an example, the first user 110 may own 10 units of a cryptocurrency. The blockchain 130a may include a record indicating that the first user 110 owns the 10 units of cryptocurrency. The first user 110 may initiate a transfer of the 10 units of cryptocurrency to the second user 115 via a wallet application executing on the first client device 120. The wallet application may store and manage a private key of the first user 110. Examples of the wallet device include a personal computer, a laptop computer, a smartphone, a personal data assistant (PDA), etc.

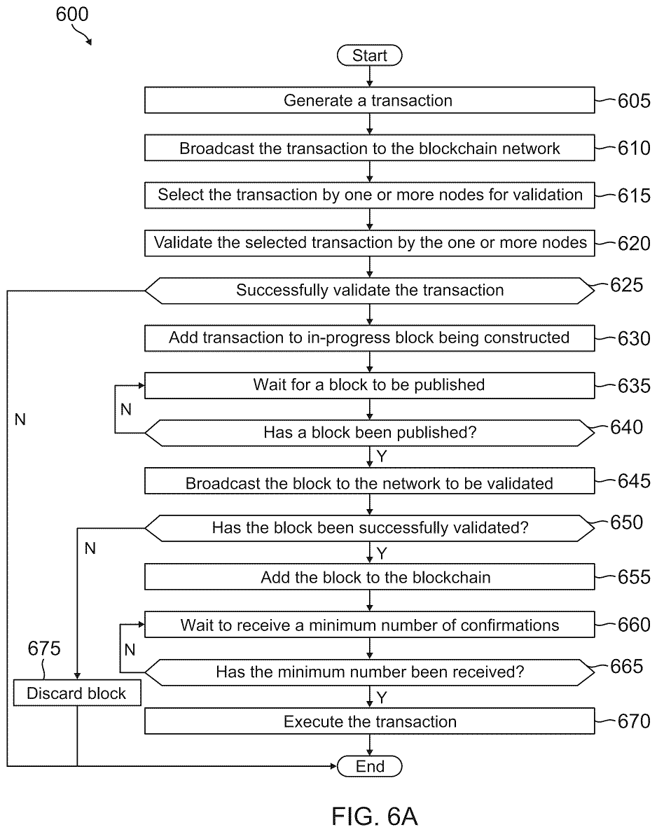

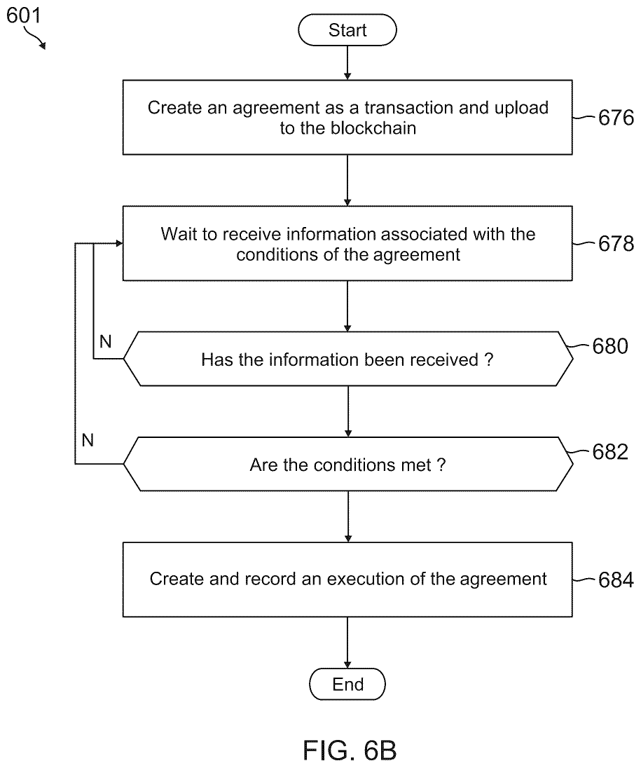

FIG. 6A is a flow diagram showing steps of an example method 600 for performing a blockchain transaction between entities, such as the first user 110 of the first client device 120 and the second user 115 of the second client device 125 in FIG. 1. The steps of the method 600 may be performed by any of the computing devices shown in FIG. 1. Alternatively or additionally, some or all of the steps of the method 600 may be performed by one or more other computing devices. Steps of the method 600 may be modified, omitted, and/or performed in other orders, and/or other steps added.

At step 605, the wallet application may generate transaction data for transferring the 10 units of cryptocurrency from the first user 110 to the second user 120. The wallet application may generate a public key for the transaction using the private key of the first user 110. In order to indicate that the first user 110 is the originator of the transaction, a digital signature may also be generated for the transaction using the private key of the first user 110. As discussed with reference to FIG. 4, the transaction data may include information, such as a blockchain address of the sender 430, the digital signature 455, transaction output information 460, and the public key of the sender 415. The transaction data may be sent to the first server 150 from the first client device 120.

The first server 150 may receive the transaction data from the first client device 120. At step 610, the first server 150 may broadcast the transaction to the blockchain network 130a. The transaction may be received by one or more nodes 205 of the blockchain network 130a. At step 615, upon receiving the transaction, a node 205 may choose to validate the transaction, for example, based on transaction fees associated with the transaction. If the transaction is not selected for validation by any of the nodes 205, then the transaction may be placed in a queue and wait to be selected by a node 205.

At step 620, each of the nodes 205 that selected the transaction may validate the transaction. Validating the transaction may include determining whether the transaction is legal or conforms to a pre-defined set of rules for that transaction, establishing user authenticity, and establishing transaction data integrity. At step 625, if the transaction is successfully validated by a node 205, the validated transaction is added to a block being constructed by that node 205 (step 630). As discussed above, since different nodes 205 may choose to validate different transactions, different nodes 205 may build or assemble a block comprising different validated transactions. Thus, the transaction associated with the first user 110 transferring 10 units of cryptocurrency to the second user 115 may be included in some blocks and not others.

At step 635, the blockchain network 130a may wait for a block to be published. Validated transactions may be added to the block being assembled by a node 205 until it reaches a minimum size specified by the blockchain. If the blockchain network 130a utilizes a proof of work consensus model, then the nodes 205 may compete for the right to add their respective blocks to the blockchain by solving a complex mathematical puzzle. The node 205 that solves its puzzle first wins the right to publish its block. As compensation, the winning node may be awarded a transaction fee associated with the transaction (e.g., from the wallet of the first user 110). Alternatively, or in addition, the winning node may be awarded compensation as an amount of cryptocurrency added to an account associated with the winning node from the blockchain network (e.g., “new” units of cryptocurrency entering circulation). This latter method of compensation and releasing new units of cryptocurrency into circulation is sometimes referred to as “mining.” At step 640, if a block has not been published, then the process 600 returns to step 635 and waits for a block to be published. However, at step 640, if a block has been published, then the process 600 proceeds to step 645.

At step 645, the published block is broadcast to the blockchain network 130a for validation. At step 650, if the block is validated by a majority of the nodes 205, then at step 655, the validated block is added to the blockchain 220. However, at step 650, if the block is not validated by a majority of the nodes 205, then the process 600 proceeds to step 675. At step 675, the block is discarded and the transactions in the discarded block are returned back to the queue. The transactions in the queue may be selected by one or more nodes 205 for the next block. The node 205 that built the discarded block may build a new next block.

At step 660, if the transaction was added to the blockchain 220, the server 150 may wait to receive a minimum number of blockchain confirmations for the transaction. At step 665, if the minimum number of confirmations for the transaction have not been received, then the process may return to step 660. However, if at step 665, the minimum number of confirmations have been received, then the process proceeds to step 670. At step 670, the transaction may be executed and assets from the first user 110 may be transferred to the second user 115. For example, the 10 units of cryptocurrency owned by the first user 110 may be transferred from a financial account of the first user 110 to a financial account of the second user 115 after the transaction receives at least three confirmations.

### Smart Contracts

A smart contract is an agreement that is stored in a blockchain and automatically executed when the agreement's predetermined terms and conditions are met. The terms and conditions of the agreement may be visible to other users of the blockchain. When the pre-defined rules are satisfied, then the relevant code is automatically executed. The agreement may be written as a script using a programming language such as Java, C++, JavaScript, VBScript, PHP, Perl, Python, Ruby, ASP, Tcl, etc. The script may be uploaded to the blockchain as a transaction on the blockchain.

As an example, the first user 110 (also referred to as tenant 110) may rent an apartment from the second user 115 (also referred to as landlord 115). A smart contract may be utilized between the tenant 110 and the landlord 115 for payment of the rent. The smart contract may indicate that the tenant 110 agrees to pay next month's rent of $1000 by the 28^{th} of the current month. The agreement may also indicate that if the tenant 110 pays the rent, then the landlord 115 provides the tenant 110 with an electronic receipt and a digital entry key to the apartment. The agreement may also indicate that if the tenant 110 pays the rent by the 28^{th} of the current month, then on the last day of the current month, both the entry key and the rent are released respectively to the tenant 110 and the landlord 115.

FIG. 6B is a flow diagram showing steps of an example method 601 for performing a smart contract transaction between entities, such as the tenant 110 and the landlord 115. The steps of the method 601 may be performed by any of the computing devices shown in FIG. 1. Alternatively or additionally, some or all of the steps of the method 601 may be performed by one or more other computing devices. Steps of the method 601 may be modified, omitted, and/or performed in other orders, and/or other steps added.

At step 676, the agreement or smart contract between the tenant 110 and the landlord 115 may be created and then submitted to the blockchain network 130a as a transaction. The transaction may be added to a block that is mined by the nodes 205 of the blockchain network 130a, the block comprising the transaction may be validated by the blockchain network 130a and then recorded in the blockchain 220 (as shown in steps 610-655 in FIG. 6A). The agreement associated with the transaction may be given a unique address for identification.

At step 678, the process 601 waits to receive information regarding the conditions relevant for the agreement. For example, the process 601 may wait to receive notification that $1000 was sent from a blockchain address associated with the tenant 110 and was received at a blockchain address associated with the landlord 115 by the 28^{th} of the current month. At step 680, if such a notification is not received, then the process 601 returns to step 678. However, if at step 680, a notification is received, then the process 601 proceeds to step 682.

At step 682, based on determining that the received notification satisfies the conditions needed to trigger execution of the various terms of the smart contract, the process 601 proceeds to step 684. However, at step 682, if it is determined that the received notification does not satisfy the conditions needed to trigger execution of the smart contract, then the process 601 returns to step 678. At step 684, the process 601 creates and records a transaction associated with execution of the smart contract. For example, the transaction may include information of the payment received, the date the payment was received, an identification of the tenant 110 and an identification of the landlord 115. The transaction may be broadcast to the blockchain network 130a and recorded in the blockchain 220 (as shown in steps 610-655 of the process 600 of FIG. 6A). If the transaction is successfully recorded in the blockchain 220, the transaction may be executed. For example, if the payment was received on the 28^{th}, then an electronic receipt may be generated and sent to the tenant 110. However, on the last day of the current month, both the digital entry key and the rent are released respectively to the tenant 110 and the landlord 115.

Smart contracts may execute based on data received from entities that are not on the blockchain or off-chain resources. For example, a smart contract may be programmed to execute if a temperature reading from a smart sensor or IoT sensor falls below 10 degrees. Smart contracts are unable to pull data from off-chain resources. Instead, such data needs to be pushed to the smart contract. Additionally, even slight variations in data may be problematic since the smart contract is replicated across multiple nodes of the network. For example, a first node may receive a temperature reading of 9.8 degrees and a second node may receive a temperature reading of 10 degrees. Since validation of a transaction is based on consensus across nodes, even small variations in the received data may result in a condition of the smart contract to be evaluated as being not satisfied. Third party services may be utilized to retrieve off-chain resource information and push this to the blockchain. These third-party services may be referred to as oracles. Oracles may be software applications, such as a big data application, or hardware, such as an IoT or smart device. For example, an oracle service may evaluate received temperature readings beforehand to determine if the readings are below 10 degrees and then push this information to the smart contract. However, utilizing oracles may introduce another possible point of failure into the overall process. Oracles may experience errors, push incorrect information or may even go out of business.

Since blockchains are immutable, amending or updating a smart contract that resides in a blockchain may be challenging and thus, more expensive and/or more restrictive than with text-based contracts.

Blockchain Enabled in-Store Purchasing

An example of blockchain enabled in-store purchasing is described with reference to the system 800 shown in FIG. 8, the process 600 shown in FIG. 6A and the process 601 shown in FIG. 6B. FIG. 8 illustrates an example of a blockchain enabled in-store purchase system 800. The system 800 includes a mobile device 805, a merchant system 810, and a server 850 connected via a network 840. The merchant system 810 may be connected via a local wireless network to various IoT devices within a store, for example, an in-store smart shelf 815, and an in-store smart checkout detector 830.

The store may include one or more smart shelves, such as the in-store smart shelf 815. The smart shelf 815 may include an RFID tag, an RFID reader, and an antenna. One or more products may be stored on the in-store smart shelf 815. Each product may include an RFID tag, such as a first product tag 820a attached to a first product 816a and a second product tag 820b attached to a second product 816b. The in-store smart shelf 815 may, based on reading the product tags 820a and 820b, send information about the products 816a and 816b throughout the day to the merchant system 810. The merchant system 810 may in turn update an inventory of products currently within the store.

A shopper may travel through the store with the mobile device 805. A digital shopping list on the mobile device 805 may include a list of items that the shopper may need to purchase. For example, the shopping list may include an item that matches the first product 816a. When the shopper is close to the in-store smart shelf 815, the mobile device 805 may notify the shopper that the first product 816a is currently available on the in-store smart shelf 815. The shopper may remove the first product 816a from the in-store smart shelf 815 and place it into a smart shopping cart 835. The smart shopping cart 835 may read the first product tag 820a as well as the product tags attached to other products that may have been placed in the smart shopping cart 835. When the shopper is ready to checkout, the shopper may walk out of the store with the shopping cart 835. As the shopper walks out of the store, the in-store smart checkout detector 830 may detect the smart shopping cart 835. The smart shopping cart 835 may communicate with the in-store smart checkout detector 830 and transmit information about the products in the smart shopping cart. The in-store smart checkout detector 830 may send information about the products, such as the first product 816a, and payment information from the mobile device 805 to the merchant system 810. The merchant system 810 may receive information from the in-store smart checkout detector 830 and the payment information and proceed to initiate purchase of the first product 816a.

Referring to step 605 of the process 600 shown in FIG. 6A, a wallet application on the mobile device 805 may generate transaction data for transferring an amount of cryptocurrency matching the sale price of the first product 816a from the shopper to the merchant. The wallet application may generate a public key for the transaction using the private key of the shopper. In order to indicate that the shopper is the originator of the transaction, a digital signature may also be generated for the transaction using the private key of the shopper. The transaction data may be sent to the server 850 from the mobile device 805.

The server 850 may receive the transaction data from the mobile device 805. At step 610, the server 850 may broadcast the transaction to the blockchain network 130a. The transaction may be received by one or more nodes 205 of the blockchain network 130a. At step 615, upon receiving the transaction, a node 205 may choose to validate the transaction, for example, based on transaction fees associated with the transaction. If the transaction is not selected for validation by any of the nodes 205, then the transaction may be placed in a queue and wait to be selected by a node 205.

At step 620, each of the nodes 205 that selected the transaction may validate the transaction. At step 625, if the transaction is successfully validated by a node 205, the validated transaction is added, at step 630, to a block being constructed by that node 205. At step 635, the blockchain network 130a may wait for a block to be published. At step 640, if a block has not been published, then the process 600 returns to step 635 and waits for a block to be published. However, at step 640, if a block has been published, then the process 600 proceeds to step 645.

At step 645, the published block is broadcast to the blockchain network 130a for validation. At step 650, if the block is validated by a majority of the nodes 205, then at step 655, the validated block is added to the blockchain 220. At step 660, if the transaction was added to the blockchain 220, the server 850 may wait to receive a minimum number of blockchain confirmations for the transaction. At step 665, if the minimum number of confirmations for the transaction have not been received, then the process may return to step 660. However, if at step 665, the minimum number of confirmations have been received, then the process proceeds to step 670. At step 670, the transaction may be executed and the sale price of the first product 816a may be transferred from the shopper to the merchant.

When the in-store smart checkout detector 830 sends information about the products, such as the first product 816a, and payment information from the mobile device 805 to the merchant system 810, a smart contract may be created between the shopper and the merchant and executed according to the process 601 shown in FIG. 6B. For example, at step 676, a smart contract between the shopper and the merchant may be created and then submitted to the blockchain network 130a as a transaction. For example, at step 678, the process 601 may wait to receive notification that an amount of cryptocurrency equal to the sale price of the first product 816a was sent from a blockchain address associated with the shopper and was received at a blockchain address associated with the merchant by the time the first product 816a is removed from the smart shopping cart 835. If the payment for the first product 816a was successfully transferred from the shopper to the merchant by the time the shopper removes the first product 816a from the smart shopping cart 835, then an electronic receipt may be generated and sent to the shopper. Otherwise, the merchant system 815 may be alerted that the shopper is attempting to leave the premises without paying for the first product 816a.

Blockchain Enabled in-Vehicle Purchasing

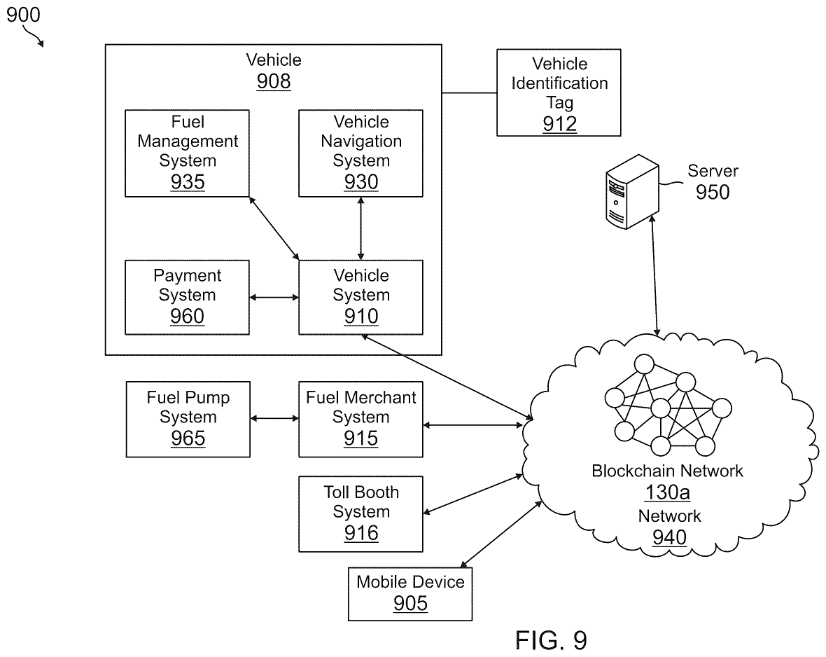

An example of blockchain enabled in-vehicle purchasing is described with reference to the system 900 shown in FIG. 9, the process 600 shown in FIG. 6A and the process 601 shown in FIG. 6B. FIG. 9 illustrates an example system 900 for blockchain enabled in-vehicle purchasing. The system 900 includes an IoT enable smart vehicle 908. The vehicle 908 may include one or more computing devices implementing a vehicle system 910, a vehicle navigation system 930, a payment system 960 and a fuel management system 935. The vehicle 908 may include a RFID tag, such as a vehicle identification tag 912. The system 900 may also include various merchant systems, such as a fuel merchant system 915, and a toll booth system 916. The system 900 may also include a mobile device 905 belonging to a driver of the vehicle 908.

When the driver gets into the vehicle 908, payment information may be loaded from the driver's mobile device 905 into the vehicle payment system 910 so it is available for secure payments to other devices in order to complete in-vehicle purchases, such as in-vehicle purchase of fuel and in-vehicle payment of tolls. The driver of the smart vehicle may pay for parking, fast food, using the IoT enabled smart vehicle 908. Additionally, the IoT enabled smart vehicle 908 may also facilitate in-vehicle purchasing of smartphone apps, music, audio books, and other goods and services.

The fuel management system 935 may perform various functions related to fuel usage and communicate with the vehicle system 916. For example, the fuel management system 935 may monitor fuel usage and based on detecting that the fuel is below a threshold, notify the vehicle system 910. The vehicle system 910 may communicate with the vehicle navigation system 930 to determine nearby fuel stations. The selection of a fuel station to may be based on various factors, such as the availability of fuel at nearby fuel stations, the vehicle's current route and location, incentives that may be offered by nearby fuel stations, etc. The vehicle system 910 may notify the driver about the selection of a fuel station and the vehicle 908 may be re-routed to the selected fuel station. Upon arriving at the selected fuel station, the driver may pull up to a fuel pump. The fuel pump may include a fuel pump system 965 configured to detect the RFID tags of vehicles, such as the vehicle identification tag 912 in order to obtain an identification of the vehicles. The fuel pump system 965 and the payment system 960 may be configured to communicate with each other. The fuel payment system 960 may send payment information to the fuel pump system 965. After the driver has completed re-fueling, the driver may simply drive away. The fuel pump system 965 may send the fuel merchant system 915 information about the identification of the vehicle 908, the amount of fuel purchased, and the payment information. The fuel merchant system 915 may use the information to complete a transaction with the driver for the purchase of the fuel. For example, the fuel merchant system 915 may communicate with the server 950 to charge the driver for the fuel according to the process 600 shown in FIG. 6A. Additionally, the fuel merchant system 915 may communicate with the server 950 in order to create a smart contract between the driver and the fuel merchant. The smart contract may be created and executed according to the process 601 shown in FIG. 6B.

### Augmented Reality (AR), Mixed Reality and Blockchain Based E-Commerce

AR or mixed reality enabled devices, such as wearable smart glasses, head mounted devices, holographic devices, or smartphone applications overlay digital content on top of a real world view, thus, enhancing a user's experience of the real world. The overlay content may be 3D models generated based on 3D scanning real world objects. AR enables users to experience online shopping in a virtual environment. For example, using AR, browse virtual stores and view 3D models of items for sale in virtual stores. Just as in the real world, customers may be able to handle and examine various physical details of the products. Blockchain smart contracts may be utilized to provide an e-commerce platform where customers may purchase items from online merchants with cryptocurrency and digital wallets. Information about a product, such as country of origin, materials, ingredients, price, description, measurements, terms and conditions, 3D model of the physical product, etc., may be hashed and recorded in a blockchain. This provides proof of ownership of virtual goods and products and enables accurate tracking of any changes made to this information. Artificial intelligence (AI) may be utilized for generating 3D models of products based on 2D images of the products. Smart contracts may be utilized to conduct transactions between merchants and customers.

As an example, a customer may shop for clothing by browsing different stores in a virtual shopping mall via a wearable AR device, such as a pair of smart glasses. The customer may examine a 3D model of a shirt as he or she would in the real world. Additionally, the customer may virtually try on the shirt using a 3D model of the customer's body. If the customer decides to purchase the shirt, the customer may initiate a transaction with the merchant of the store. A transaction may be submitted to the blockchain via the customer's digital wallet to transfer money (cryptocurrency) from the customer to the merchant. Various smart contracts may be utilized to implement various aspects of the e-commerce process. For example, based on detecting that the sale price of the shirt has been successfully transferred from the customer to the merchant, a smart contract may be executed to initiate shipment of the shirt from the merchant's warehouse to the customer. As described above with reference to supply chain monitoring and tracking, RFID tags and other IoT devices may be utilized to track the shipment of the shirt from the merchant's warehouse to the delivery of the shirt to the customer's residence.

### Quantum Computing

One of the concerns of quantum computing is that it may increase the probability of breaking cryptographic algorithms and thus, weaken overall security for the blockchain. This may be addressed by requiring larger key sizes for blockchain asymmetric-key pairs of cryptographic algorithms. In some cases, if there is a concern that a block may be decrypted in the future, a dynamically changing cryptographic hash may be utilized. A different cryptographic hash may be dynamically selected for a particular block or the entire blockchain based on various factors, such as whether there is a concern that the block will be decrypted in the future, increasing a strength of the hash, utilizing a hash that is better suited for protecting privacy. In some cases, different cryptographic hashes may be selected for different blocks.

### Anonymity and Privacy

As discussed above, the use of a private/public key pair to establish user authenticity during validation of a blockchain transaction provides some privacy as it does not reveal user identity. However, the transactions stored on a blockchain may be visible to the public. It has been shown that user identity may be derived from the publicly available transaction information.

### Blockchain Size

Depending on a frequency at which events are recorded in a blockchain, the size of the blockchain may grow quickly. Computing/storage capacity (i.e., faster processors, larger storage components) may be needed to support the expansion of the blockchain. In some cases, blocks may be compressed prior to being added to the chain. In some cases, blocks may be eliminated, for example, at the beginning of the blockchain, when they become stale or irrelevant. As an example, a method for “replacing” the first 1000 transactions with a new block that effectively mimics the hash of the 1000 transactions may be useful for managing blockchain size.

### Blockchain Immutability

In some cases, content in a blockchain may need to be deleted. For example, content may need to be deleted if there is a security breach or if the content is no longer relevant. A level of immutability of a blockchain may depend on a type of the blockchain. For example, changing content may be difficult in a public blockchain due to its possible impact on a large number of users. According to some techniques, data stored in a private blockchain, or a public blockchain controlled by a few entities may be changed by recording a flag (current block) where the change is being made, and adding the current block (referred to by the flag) to the blockchain. The added block may then indicate the change made to the previous block.

As another example, a blockchain may need to be changed to resolve a broken link. For example, the hash of a changed block may no longer match the hash stored in the block+1. In some cases, the blockchain may need to be changed in order to reverse the results of illegal transactions. In some cases, the blockchain may need to be changed to address software errors, erroneous transactions, or remove information that is confidential or required by law to be removed. If the blockchain is immutable, these errors and information may be permanently embedded in the blockchain. Additionally, the blockchain may need to be changed to comply with regulatory concerns, such as the European Union's incoming General Data Protection Regulation (GDPR), or California Consumer Privacy Act (CCPA), regarding consumer data privacy and ownership rights, US Fair Credit Reporting Act, and the SEC's “Regulation SP,” which require that recorded user identifiable personal financial data be redactable.

Some techniques may allow modifications to the blockchain to address software errors, legal and regulatory requirements, etc., by allowing designated authorities to edit, rewrite or remove previous blocks of information without breaking the blockchain. Such techniques may enable blockchain editing by using a variation of a “chameleon” hash function, through the use of secure private keys. This editing may allow smart contracts that were flawed at issue to be updated so that the changes carry over to subsequent smart contracts in the blockchain. Using these techniques, blocks that have been changed may be using a “scar” or mark that cannot be removed, even by trusted parties.

According to some techniques, when a block is hashed, any confidential information, such as personally identifiable information, and IP addresses, is not included in the hash because it is not part of the data values that were hashed. But because there is no hash of the confidential information, it may be changed. According to some techniques, the confidential information may not be placed or recorded into the blockchain. Rather the information may reside in a file that is external to the blockchain. A hash of that file, however, may be recorded in the blockchain. For example, a user's confidential information may be deleted locally without affecting the blockchain.

As another example, assuming that all content included in a block in a blockchain cannot be changed after a block is added to the blockchain, a determination may be made before adding data to the blockchain of whether some or all of that data may need to be deleted at a later time. For example, confidential information (i.e., data to be deleted at a later time) may be stored as a file that is external to the block and the blockchain. For the purposes of creating the block, a link to the file containing the confidential information and a hash of the file containing the confidential information file may be added to the block. An example of a link would be an HTTP link. During confirmation of the block that is to be added to the blockchain, the network nodes may be able to access the confidential information and verify that the confidential information based on the hash value of the file in the block. Because the hash value of the file is a part of the block, the file containing the confidential information may not be easily changed. However, it may be possible to change the confidential information file by changing the data therein and adding a nonce. This may seek to change the nonce until the resulting hash equals the hash that is stored in the blockchain. However, this would be difficult (probably near impossible), and an inspection of the modified confidential information file would reveal the added nonce, which may then raise suspicion that information was changed since it was first added to the blockchain.

Files containing confidential information may be encrypted (e.g., through an asymmetric key encryption function) prior to the hashing operation. When “deleting” the confidential information, the file containing the confidential information may be deleted or removed resulting in the link, which is stored in the blockchain, being ineffective for retrieving the file. The hash of the file, and the link, remain in the blockchain so that the linking of the blocks through hash functions is not affected. However, because of this change, a transaction that is part of the block or part of a different special block could be added to the blockchain to indicate that the link is no longer effective and the confidential information file is no longer part of the blockchain. This may effectively keep confidential information out of the blockchain while providing the confidential information to users of the blockchain and proof of authenticity of the confidential information before it is deleted from the blockchain. This may come with drawbacks because access to data implies that such data may be stored. Accordingly, those with access to the confidential information file, while it was part of the blockchain, may have stored that information in another location that may no longer be reachable during the “deleting” operation discussed above.

### 51% Attack

A “51% attack” refers to an individual mining node or a group of mining nodes controlling more than 50% of a blockchain network's mining power, also known as hash rate or hash power. The hash rate is a measure of the rate at which hashes are being computed on the blockchain network. As described above, hashing may include taking an input string of a given length, and running it through a cryptographic hash function in order to produce an output of a fixed length. A blockchain network's hash rate may be expressed in terms of 1 KH/s (kilohash per second) which is 1,000 hashes per second, 1 MH/s (megahash per second) which is 1,000,000 hashes per second, 1 TH/s (terahash per second) which is 1,000,000,000,000 hashes per second, or 1 PH/s (petahash per second) which is 1,000,000,000,000,000 hashes per second. As an example, a mining node in a blockchain utilizing a proof of work consensus model (PoW) may perform hashing in order to find a solution to a difficult mathematical problem. The hash rate of the mining node may depend on the computational resources available to that node. A mining node that successfully solves the mathematical problem may be able to add a block to the blockchain. Thus, by ensuring that invalid transactions cannot be included in a block, mining nodes increase the reliability of the network. Transactions may be deemed invalid if they attempt to spend more money than is currently owned or engage in double spending. If a mining node intentionally or unintentionally includes an invalid transaction in a block, then the block will not be validated by the network. Additionally, nodes that accept the invalid block as valid and proceed to add blocks on top of the invalid block will also end up wasting computational resources. Thus, mining nodes are discouraged from cheating by intentionally adding invalid transactions to blocks and accepting invalid blocks as valid.

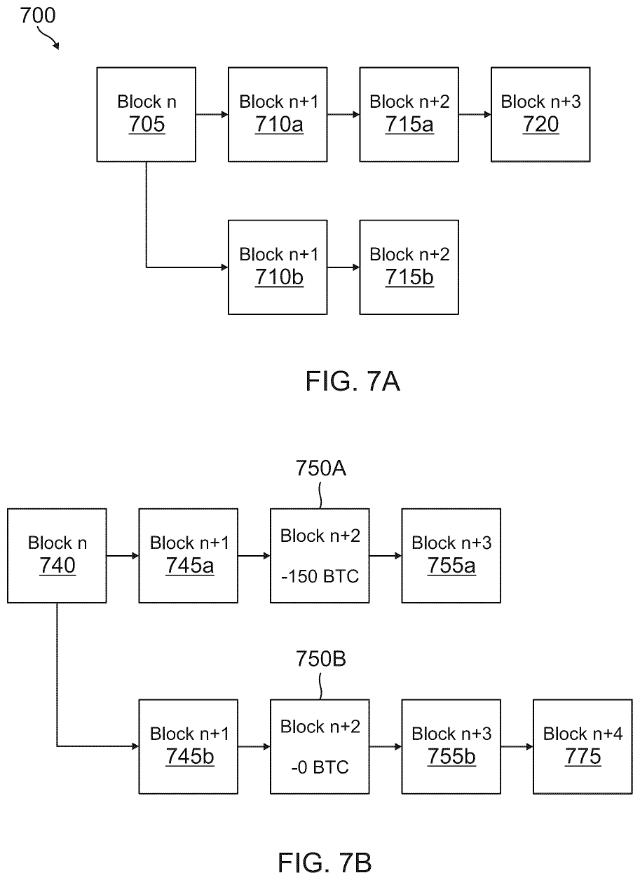

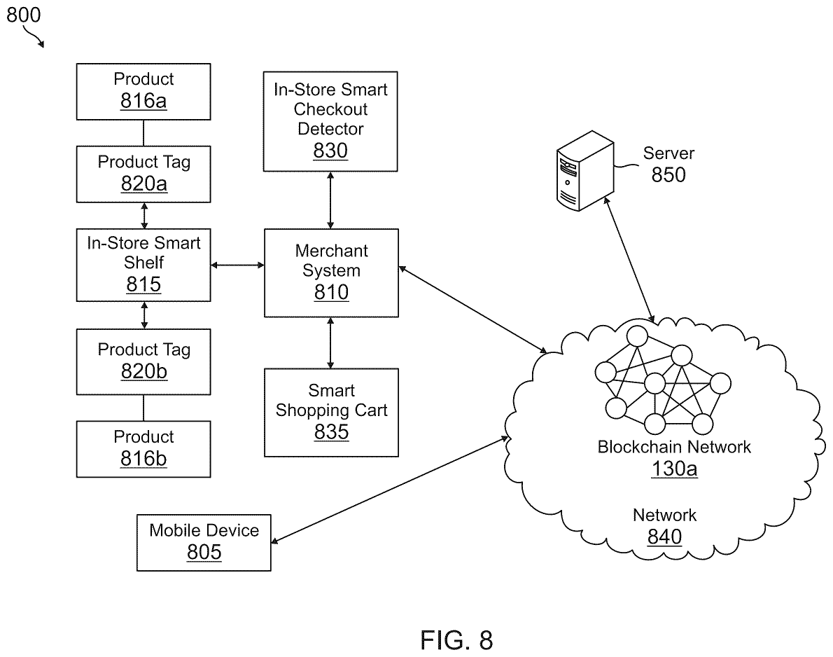

An entity may be able to disrupt the network by gaining control of 50% of a network's hash rate. In a 51% attack, a blockchain node may intentionally reverse or overwrite transactions and engage in double spending. When a node generates a valid block of transactions, it broadcasts the block to the network for validation. In some cases, a node controlling more than 50% of a network's hash rate may mine blocks in private without broadcasting them to the network. In such a scenario, the rest of the network may follow a public version of the blockchain while the controlling node may be following its private version of the blockchain. FIG. 7A shows a fraudulent and valid version of a blockchain 700. The valid blockchain on the top comprises the valid blocks 705, 710a, 715a, and 720. The fraudulent blockchain on the bottom is not broadcast to the network and includes the blocks 705, 710b, 715b, and an invalid block 720.

FIG. 7B shows another fraudulent and valid version of a blockchain. The valid version of the blockchain includes nodes 740, 745a, 750a, and 755a. The fraudulent version of the blockchain includes nodes 740, 745b, 750b, 755b, and 775. However, following the longest chain rule, the network may select and utilize the private or fraudulent blockchain comprising nodes 740, 745b, 750b, 755b and 775. Since it is the longest chain, previous transactions may be updated according to this chain. The cheating node may include transactions that spend money, such as the block 750b including the transaction for 150 BTC, on the public or fraudulent version of the blockchain without including these transactions in the private version of the blockchain. Thus, in the private version of the blockchain, the cheating node may continue to own the spent 150 BTC. When the cheating node controls more than 50% of the hashing resources of the network, it may be able to broadcast its private version of the blockchain and continue to create blocks on the private blockchain faster than the rest of the network, thus, resulting in a longer blockchain. Since there are two versions of the blockchain, the network may select the longest or fraudulent private blockchain as the valid blockchain. As a result, the rest of the network may be forced to use the longer blockchain. The public or valid version of the blockchain may then be discarded or abandoned and all transactions in this blockchain that are not also in the private or fraudulent version of the blockchain may be reversed. The controlling or cheating node may continue to own the spent money because the spending transactions are not included on the fraudulent version of the blockchain, and the cheating node may therefore, spend that money in future transactions.

Because of the financial resources needed to obtain more hashing power than the rest of the entire network combined, a successful 51% attack may generally be challenging to achieve. However, it would be less expensive to achieve a 51% attack on a network with a lower hash rate than one with a higher hash rate. Additionally, the probability of a successful 51% attack increases with the use of mining pools in which multiple nodes may combine their computational resources, for example, when mining is performed from the same mining pool.

### Description Of Exemplary Embodiments

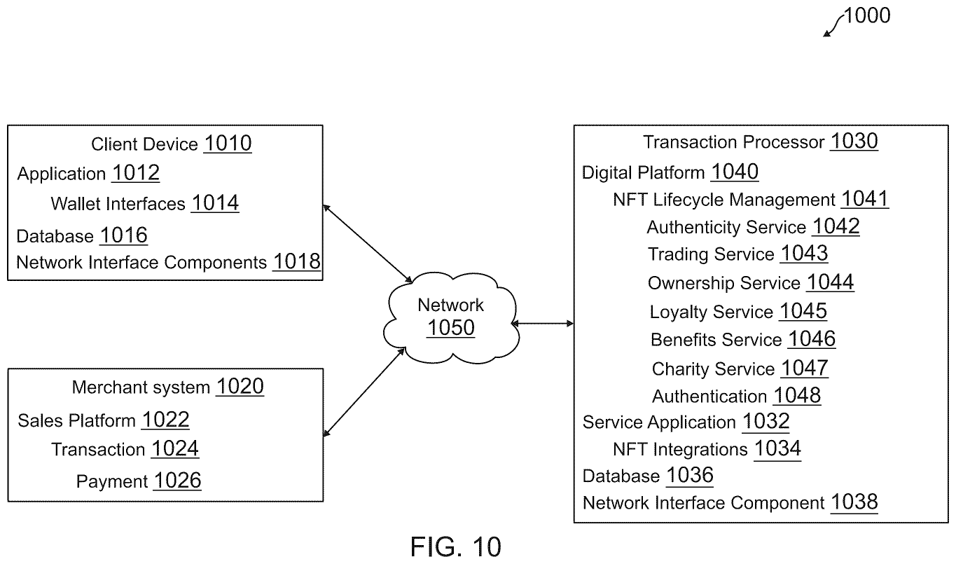

FIG. 10 is a block diagram of a networked system 1000 suitable for implementing the processes described herein, according to an embodiment. As shown, system 1000 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 10 may be deployed in other ways, and that the operations performed, and/or the services provided by such devices and/or servers, may be combined or separated for a given embodiment and may be performed by a greater number or fewer number of devices and/or servers. One or more devices and/or servers may be operated and/or maintained by the same or different entities.

System 1000 includes a client device 1010, a merchant system 1020, and a transaction processor 1030 in communication over a network 1050, and may also include a distributed ledger network for wallet addresses (not shown). Client device 1010 may be used to request use of NFT computing services that have been unified in a single application or suite of related and integrated applications, websites or domains, or the like provided by a digital platform 1040 of transaction processor 1030, which may be facilitated through digital accounts and wallets that allow for use of cryptocurrency and NFTs provided by transaction processor 1030. For NFT ownership, digital platform 1040 may unify different applications and services used over the lifetime of ownership, and therefore may provide lifecycle management of NFTs on behalf of users. Transaction processor 1030 may facilitate NFT lifecycle management for NFTs held by a user associated with client device 1010 and/or stored to a digital wallet with transaction processor 1030.

Client device 1010, merchant system 1020, and transaction processor 1030 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 1000, and/or accessible over network 1050.

Client device 1010 may be implemented using any appropriate hardware and software configured for wired and/or wireless communication with merchant system 1020 and/or transaction processor 1030 for processing payments and transaction that may be associated with NFTs and other tokens and digital assets that may not be fungible (e.g., easily traded for the same or similar digital asset) or otherwise may not normally be classified as cryptocurrency or the like. Client device 1010 may correspond to an individual user, entity, or the like that utilizes a network and platform provided by transaction processor 1030 for different NFT computing services including those associated with NFT lifecycle management. In various embodiments, client device 1010 may be implemented as a personal computer (PC), a smart phone, laptop/tablet computer, wristwatch with appropriate computer hardware resources, other type of wearable computing device, and/or other types of computing devices capable of transmitting and/or receiving data. Although only one computing device is shown, a plurality of computing devices may function similarly.

Client device 1010 of FIG. 10 contains an application 1012, a database 1016, and a network interface component 1018. Application 1012 may correspond to executable processes, procedures, and/or applications with associated hardware. In other embodiments, client device 1010 may include additional or different software as required.

Application 1012 may correspond to one or more processes to execute modules and associated devices of client device 1010 to provide a convenient set of interfaces including wallet interfaces 1014 to permit a user of client device 1010 to access and utilize a digital wallet including financial instruments, cryptocurrency, and/or NFTs. As such, wallet interfaces 1014 may permit the user to access and use a digital wallet having available NFTs and/or digital certificates or other proofs of ownership (e.g., by referencing a signed block identifying the NFT, digital asset, and owner) for NFTs. In this regard, application 1012 may correspond to specialized hardware and/or software utilized by client device 1010 that may provide transaction processing to purchase and sell NFTs on different marketplaces including a digital NFT marketplace of digital platform 1040, where the cryptocurrency may be sent to, or requested from, a digital wallet and wallet address controlled and managed by digital platform 1040 on transaction processor 1030. Application 1012 may be used to engage in trades, exchanges, purchases, sales, and the like of NFTs as digital assets on a digital marketplace. Exchange, conversion, and/or sale of NFTs may be done through wallet interfaces 1014, which may be accessed using a single and/or unified login of digital platform 1040 that enables access to the different NFT computing services of the user. Transactions of NFTs and other digital assets be performed by exchanging private encryption keys, digital certificates, or other requirements for proof of ownership between digital wallets, as described herein. Application 1012 may also be used to receive a receipt or other information based on transaction processing.

Further, wallet interfaces 1014 may unite and unify the different computing services in a simplified set of interfaces and through a single application, requiring a single or limited set of logins for the different computing services. Once accessed, wallet interfaces 1014 may also be used to access other computing services used during NFT lifecycle management including valuation, ownership perks, discounts, charity, and the like. Application 1012 may correspond to a general browser application configured to retrieve, present, and communicate information over the Internet (e.g., utilize resources on the World Wide Web) or a private network. For example, application 1012 may provide a web browser, which may send and receive information over network 1050, including retrieving website information, presenting the website information to the user, and/or communicating information to the website, including accessing and providing wallet interfaces 1014 on client device 1010. Application 1012 may also include a dedicated application of transaction processor 1030 or other entity (e.g., transaction processor 1030), which may be configured to provide access to the unified NFT services and experiences from digital platform 1040.

Client device 1010 may further include database 1016 which may include, for example, identifiers such as operating system registry entries, cookies associated with application 1012 and/or other applications, identifiers associated with hardware of client device 1010, or other appropriate identifiers. Identifiers in database 1016 may be used by a payment/service provider to associate client device 1010 with a particular account maintained by payment/service provider associated with transaction processor 1030. Database 1016 may also further store received NFT transaction data and/or data for NFTs, including private keys, NFT discount codes, offers and/or extensions of access to owner perks or benefits for NFT ownership, and other NFT lifecycle data.

Client device 1010 includes at least one network interface component 1018 adapted to communicate with merchant system 1020, transaction processor 1030, and/or other devices or servers over network 1050. In various embodiments, network interface component 1018 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Merchant system 1020 may be implemented as a communication device that may utilize appropriate hardware and software configured for wired and/or wireless communication with client device 1010, transaction processor 1030, and/or another device, server, or system. For example, in one embodiment, merchant system 1020 may be implemented as a personal computer (PC), a smart phone, laptop/tablet computer, wristwatch with appropriate computer hardware resources, wearable computing device, and/or other types of computing devices capable of transmitting and/or receiving data. Although only one device is shown, a plurality of devices may function similarly and/or be connected to provide the functionalities described herein.

Merchant system 1020 of FIG. 1 includes and/or is associated with a sales platform 1022 an implementation of which is discussed further below. Sales platform 1022 may correspond to executable processes, procedures, and/or applications with associated hardware. In other embodiments, merchant system 1020 may include additional or different modules having specialized hardware and/or software as required.

Sales platform 1022 may correspond to one or more processes to execute software modules and associated components of merchant system 1020 to provide features, services, and other operations by a merchant for consumers over network 1050, which may include merchant sales operations, POS device processing and/or operations, online merchant marketplaces, sales and inventory services, and the like. Further, sales platform 1022 may enable use of NFTs for payments or may provide for benefits, discounts, memberships, and the like for ownership of an NFT. Such ownership benefits may be provided to users at checkout and/or on proof of ownership of the NFT, such as by directing a merchant or merchant device to a blockchain record, providing proof of ownership of private keys or digital certificates of NFT ownership, or the like. As such, sales platform 1022 may provide owners with certain benefits or services, which may be availed through the NFT lifecycle management services provided by digital platform 1040, as discussed herein.

Sales platform 1022 may be used to process transactions, which may correspond to payments made by customers or other users to the merchant and/or a merchant account of the merchant. As such, sales platform 1022 may provide payment and/or electronic transaction processing services, as well as other computing services for transaction processing. This may further include processes for merchant sales, inventory, return or exchange, risk analysis, and other services a merchant may require during the course of their business and sales. In this regard, sales platform 1022 may correspond to specialized software utilized by a merchant or other user of merchant system 1020 that may provide applications and application data based on the account and/or computing services enabled by transaction processor 1030 after merchant onboarding. Sales platform 1022 may provide and/or process items for sale with merchant system 1020 and/or a user interacting with merchant system 1020 (e.g., using a POS device, the website, mobile application, or another merchant marketplace platform). In certain examples, sales platform 1022 may be accessible over the Internet and provide for sales with merchant system 1020 over network 1050.

In some embodiments, sales platform 1022 may correspond to and/or be used to configure a checkout application at a physical merchant location, such as the application(s) of a point-of-sale (POS) device used to provide sales at physical locations. For example, sales platform 1022 may be used to establish a transaction once a customer has provided and/or an employee associated with merchant system 1020 has entered one or more items for purchase to the transaction for processing. Once a payment amount is determined for the item(s) to be purchased by the user, sales platform 1022 may request payment for the transaction. Payment may be provided using electronic transaction processing services enabled and/or provided by transaction processor 1030. In this regard, payment may be received from a user and may be processed using transaction processor 1030. After receipt of payment and/or confirmation of the payment, sales platform 1022 may then process a payment to the merchant associated with merchant system 1020. In other embodiments, merchant system 1020 may be used to host, provide, and/or access and maintain a website of the merchant, a web-based application, or the like, which may provide similar checkout and transaction processing services. These checkout services may incorporate the use of NFTs as a payment instrument or to provide a benefit, discount, membership, or the like during transaction processing.

Merchant system 1020 may further include or have access to a database, which may correspond to different types of data storage and components including cloud computing storage nodes, remote data stores and database systems, distributed database systems over network 1050, and the like used to store various applications and data. The database may include, for example, identifiers such as operating system registry entries, cookies associated with sales platform 1022 and/or other applications, identifiers associated with hardware of merchant system 1020, or other appropriate identifiers, such as identifiers used for payment/user/device authentication or identification.

Merchant system 1020 may also include at least one network interface component adapted to communicate with client device 1010, transaction processor 1030 and/or other devices, servers, and/or systems. In various embodiments, the network interface component may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Transaction processor 1030 may be maintained, for example, by an online service provider, which may provide operations for NFT lifecycle management for NFTs held by one or more users in digital wallets. In such embodiments, transaction processor 1030 may provide digital platform 1040 to interface with and/or utilize wallet addresses for such NFT lifecycle management, which may include providing and/or utilizing one or more computing services for different NFT services, usages, ownership changes, ownership proofs, valuations, and the like. Transaction processor 1030 includes one or more processing applications which may be configured to interact with client device 1010, merchant system 1020, and/or other devices, servers, and systems for NFT services. In one example, transaction processor 1030 may be provided by PAYPAL®, Inc. of San Jose, CA, USA. However, in other embodiments, transaction processor 1030 may be maintained by or include another type of service provider.

Transaction processor 1030 of FIG. 10 includes digital platform 1040, service applications 1032, a database 1036, and a network interface component 1038. Digital platform 1040 and/or service applications 1032 may correspond to executable processes, procedures, and/or applications with associated hardware. In other embodiments, transaction processor 1030 may include additional or different modules having specialized hardware and/or software as required.

Digital platform 1040 may correspond to one or more processes to execute software using associated hardware components of transaction processor 1030 to provide computing services associated with NFT ownership including acquiring and divesting ownership, which may be based on NFTs held in a digital wallet of a user and/or owned in some capacity by the user. In some embodiments, digital platform 1040 may manage NFTs and NFT ownership for one or more users, as well as an NFT exchange or marketplace platform where users may utilize cold (e.g., offline) and/or hot (e.g., online) digital wallets to engage in trades and exchanges of NFTs and other digital assets. Digital platform 1040 may receive requests to use one or more computing services associated with an NFT and/or ownership of an NFT, which may be provided through and/or managed by NFT lifecycle management 1041 of digital platform 1040.

Transaction processor 1030, as well as client device 1010, may have access to, own or control assets associated with, or otherwise interact with certain blockchains and/or NFTs, which may be used during the course of NFT ownership and/or by NFT lifecycle management 1041. For example, distributed transaction participants and/or network participants for blockchains corresponding to cryptocurrencies and NFTs may correspond to networks of devices that may communicate to share, update, and maintain a distributed ledger for a blockchain and cryptocurrency. The distributed network participants may include transaction participants and miners, where transaction participants may process transactions and record those transactions and exchanges of cryptocurrencies and/or virtual currencies using a blockchain. A record may be required to be generated, updated, and maintained on a blockchain. Digital wallets may correspond to hot or cold storage components for cryptocurrency and/or NFTs, and may each have one or more of wallet addresses, which may be used to transfer cryptocurrency, NFTs, and/or other digital assets to and/or from the storage component associated with or designated by the wallet address (e.g., by designating an address on a network where privacy cryptographic keys for cryptocurrency, NFTs, or other digital assets may be sent to and/or from a device). Wallet addresses may reside on a blockchain and blockchain network and may be used to send and/or receive NFTs when conducting transactions.

Digital wallets for cryptocurrency and/or NFTs further include encryption keys, digital certificates, and/or other proofs of ownership for cryptocurrency, NFTs, and/or other digital assets, such as private cryptographic keys of cryptocurrency or digital signatures or certificates, which may be used to sign transactions and digital records and convey possession and ownership of the cryptocurrency of NFTs. While keys generally may designate particular cryptocurrency values or pieces and have a value or amount of the cryptocurrencies, NFTs by nature are non-fungible. As such, digital certificates or keys may directly point to the corresponding digital asset for each NFT, and there may be a unique correspondence between a certificate, key, or other identifier and the correspond digital asset and NFT. Thus, the NFTs for a digital wallet may each be unique and may each have a corresponding lifecycle of ownership that is managed by NFT lifecycle management 1041.

NFT lifecycle management 1041 includes a suite of computing services and digital products unified in a single digital platform, website, and/or application. These services may include an authenticity service 1042, a trading service 1043, an ownership service 1044, a loyalty service 1045, a benefits service 1046, and/or a charity service 1047. An authentication 1048 may be provided to unify logins and authentication requirements for each of the services of NFT lifecycle management 1041, thereby providing a faster, more efficient, and secure trust process for access to and/or use of NFTs and/or NFT ownership rights and privileges. In this regard, authentication 1048 may correspond to a single login requirement and/or authentication requirement, or a limited number as may be required by policy, rule, law, or regulation. Authentication 1048 may require a user to provide a login, password, secret, and/or other information that verifies an identity of the user and/or the user's right to access and/or utilize a digital account, digital wallet, and/or NFTs held by such an account or wallet. Authentication 1048 may provide the authenticated user with access to the different computing services and digital product of NFT lifecycle management 1041, and may also track the user's experience or journey from login to logout so that re-authentications are minimized and the user is not required to login for each computing service availed.

Authenticity service 1042 may correspond to a computing service and/or product that may verify the authenticity, originality, source, and/or minting event for an NFT, such that the NFT can be proven to be what it is purported to be. In some embodiments, authenticity service 1042 may provide a digital certificate, badge, or other identifier, which may be recorded on a blockchain, for an authenticity of an NFT being “proven” or meeting a particular standard. Where the authenticity is proven and/or is held to be verified by authenticity service 1042, the authenticity may be required to meet a certain threshold, requirement, or score based on a set of factors, a scoring algorithm or process, and the like. For different NFTs, authenticity service 1042 may analyze the blockchain records to identify continuity in ownership and the minting event that created the NFT, as well as other lifecycle information including different lifetime events, ownership changes, and/or valuations. Authenticity service 1042 may integrate with a marketplace or exchange platform for trading service 1043 to authenticate other NFTs when trading, provide proof of NFT authenticity to other users, and the like.

Trading service 1043 may correspond to a computing service where NFTs may be bought, sold, and/or traded, but may also be minted or may be acquired through a separate but linked or incorporated minting event. Trading service 1043 may include and/or correspond to an online digital marketplace and/or exchange where NFTs may be offered for sale, browsed, purchased, and/or traded. Trading service 1043 may provide other trading services including escrow services as a trusted holder of NFTs, cryptocurrency, and/or fiat currency when buying, selling, and/or trading, and/or verification of NFTs through authenticity service 1042. Trading service 1043 may be linked to one or more digital wallets of the users of digital platform 1040, and may exchange NFTs between different transaction participants using corresponding wallet addresses. Ownership service 144 may be used to determine the ownership of different NFTs, as well as the rights and privileges of those owners. In this regard, ownership service 144 may include information for registered NFT groups, collections, or the like, which may provide their corresponding ownership rights and privileges, but may also perform a lookup of other NFTs on the corresponding blockchain to determine the minting event of each NFT and the corresponding ownership group, collection, or the like for purposes of ownerships benefits. Ownership service 1044 may, once the ownership benefits have been determined, provide such benefits to the NFT holders via the digital wallets and/or one or more notifications or alerts to such owners.

Loyalty service 1045, benefits service 1046, and charity service 1047 may also correspond to ownership benefits, perks, or privileges that users may receive from ownership of one or more NFTs. In this regard, loyalty service 1045 may correspond to a computing service used to discover and provide the various NFT loyalty programs that NFTs may offer owners, as well as provide a loyalty program that may be used for purchasers of NFTs in the same collection, multiple NFTs in a collection, and the like. Loyalty service 1045 may be engaged generally by users to acquire points and receive rewards, such as for items, travel, or other purchases, or may be provided during checkout to receive discounts and benefits during transaction processing. Loyalty service 1045 may also specifically target certain NFT purchasers and other users that may be interested in certain NFTs, minting events, collections, and other NFT related digital objects, items, or services. Benefits service 1046 may provide a similar service where an NFT may convey a particular benefit, such as membership to a club or gym, by virtue of ownership. Thus, benefits service 1046 may discover such benefits for NFTs and provide those benefits to users. Charity service 1047 may provide a process by which NFTs may be used toward donating to a cause, such as by donating an NFT to the cause and allowing a charity for the cause to collect proceeds on a sale of the NFT. The proceeds may then be used by the charity toward benefiting the cause, research associated with the cause, and the like. The operations and features of NFT lifecycle management 1041 are discussed in further detail below with regard to FIGS. 11A-13.

Service applications 1032 may correspond to one or more processes to execute modules and associated specialized hardware of transaction processor 1030 to provide computing services to users, which may be associated with NFT lifecycle management 1041 including transaction processing and the like. For example, service applications 1032 may be used to process payments and other services to one or more users, merchants, and/or other entities for transactions, which may include NFT related services and/or services that may be provided for owners of NFTs and/or prosecutive NFT purchasers. In some embodiments, service applications 1032 may be used by a user associated with client device 1010 to establish a payment account and/or digital wallet, which may be used to process transactions and/or buy/sell/transfer cryptocurrency and/or NFTs. In various embodiments, an amount of funds in one or more currencies may be established for the account including cryptocurrency, as well as other unique and/or non-fungible digital assets including NFTs. These fungible and non-fungible assets may be received, accessed, used, and/or exchanged, sold, or otherwise acquired or divested of ownership through one or more processes of NFT lifecycle management 1401 and service applications 1032.

A digital wallet token for the wallet may be used to send and process payments, for example, through an interface provided by transaction processor 1030. The digital wallet may be accessed and/or used through a browser and/or native software application executed by client device 1010 and engage in electronic transaction processing and digital asset exchanges, such as using cryptocurrency and/or NFTs. Service applications 1032 may be used to access digital wallets for use in processing transactions. In this regard, client device 1010 may establish one or more of transactions, which may be performed online or at physical merchant locations. The one or more transactions may correspond to checkout or payment requests where an amount of funds is to be paid to a seller, merchant, or other entity by a buyer, consumer, or similar entity.

Service applications 1032 may interface with digital platform 1040 when providing computing services and other digital products for NFT usage to users, which may occur using NFT integrations 1034 for service applications 1032. For example, when performing transaction processing, service applications 1032 may may utilize one of NFT integrations 1034 with loyalty service 1045 or benefits service 1046 to determine if the user may apply any discounts or savings to the transaction, or may determine whether the transaction is eligible from any benefits or upgrades based on ownership rights or privileges for particular NFTs. In other embodiments, service application 1032 may be used to provide the services and components of NFT lifecycle management 1041 with data for providing a computing service, such as NFT sales and/or marketplace data, blockchain information and/or records for NFT verification, and the like. Authentication 1048 may be used with service applications 1032 to provide a unified authentication service for the different applications, platforms, websites, and the like that are unified and provided through digital platform 1040 for NFT usage. Service applications 1032 may be used to record and provide a transaction history for transactions for NFTs, such as ownership changes, which may be used to update a distributed ledger and one or more blocks or records on a blockchain.

Additionally, transaction processor 1030 includes database 1036. Database 1036 may store various identifiers associated with digital wallets and wallet addresses, as well as account data, including payment instruments, financial information, account balances, authentication credentials, transaction processing histories and data for processed transactions, and the like. Although database 1036 is shown as residing on transaction processor 1030 as a database, in other embodiments, other types of data storage and components may be used including cloud computing storage nodes, remote data stores and database systems, distributed database systems over network 1050 and/or of a computing system associated with transaction processor 1030 and the like.

Digital wallets used by transaction processor 1030 may have corresponding wallet addresses on a blockchain managed and/or provided through a distributed ledger network. These addresses may be stored and/or maintained by transaction processor 1030 in database 1036 or similar storage component for wallet addresses. The addresses may be used by users, entities, or the like, and may be associated with a digital wallet or other blockchain digital account for sending and receiving cryptocurrencies and/or digital assets including ownership proofs for NFTS. As such, the distributed ledger network may correspond to multiple different devices, servers, or other processing nodes that may maintain the digital ledger for the blockchain, verify transactions, write and verify blocks, and the like, which may include providing wallet addresses for cryptocurrency and NFT transactions. Wallet addresses may correspond to one or more cryptocurrencies, NFTs, and/or blockchains, and may include a string of letters, numbers, or other characters uniquely identifying an address, endpoint, or the like on a network and blockchain. Wallet addresses may be generated from public cryptographic keys and may be used to send and receive private cryptographic keys for cryptocurrency and/or NFTs, digital certificates or signatures associated with NFT ownership, and the like.

Wallet addresses may reside on and/or be affiliated with a blockchain such that the address allows for transfer of cryptocurrency and NFTs to and from a digital wallet that stores the corresponding private cryptographic keys or digital certificates that verify ownership. Wallet addresses may be managed by a computing device and/or application, which may be accessible over the Internet (e.g., network 1050) and provide for interfacing with digital wallets and wallet applications corresponding to wallet addresses. In this regard, wallet addresses may be associated with a digital wallet that may correspond to an online or offline storage component of NFTs and/or other digital certificates, keys, and the like.

In various embodiments, transaction processor 1030 includes at least one network interface component 1038 adapted to communicate with client device 1010, merchant system 1020, and/or another device/server for a merchant over network 1050. In various embodiments, network interface component 1038 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 1050 may be implemented as a single network or a combination of multiple networks. For example, in various embodiments, network 1050 may include the Internet or one or more intranets, landline networks, wireless networks, and/or other appropriate types of networks. Thus, network 1050 may correspond to small scale communication networks, such as a private or local area network, or a larger scale network, such as a wide area network or the Internet, accessible by the various components of system 1000.

Although various components of system 1000 are described separately, functionality of the various components may be combined and/or performed by a single component and/or multiple computing devices in communication without departing from the invention.

FIGS. 11A and 11B illustrate exemplary system architectures 1100a and 1100b for a unified NFT digital platform for managing lifecycles of NFT ownership, according to an embodiment. System architecture 1100a shows an example of the components of digital platform 1040 in more detail, which may be used to provide the computing services and digital products to users that own or have an ownership stake or right to one or more NFTs. System architecture 1100b shows an integration of the token generation and verification process 1128 for use with different NFT services provided to owners or holders of NFTs. The system components and features of system architectures 1100a and 1100b may correspond to digital platform 1040 of transaction processor 1030 in system 1000 of FIG. 10.

In system architecture 1100a, an example of digital platform 1040 from system 1000 is shown in further detail. Digital platform 1040 may include a blockchain platform 1102 as a core component for interaction with different NFTs and NFT blockchains to provide the NFT services and digital products discussed herein. In this regard, blockchain platform 1102 may provide an interface with the different blockchains for record reading, writing, and/or distributing, as well as maintaining a node on different blockchains and/or acting as one or more of the distributed participant nodes, machines, or computers for purposes of maintaining, updating, and writing, to the digital ledger and/or blocks on the digital ledger, as well as securely storing records and/or performing network consensus for digital ledger immutability. Blockchain platform 1102 may also provide digital wallet addresses and/or addresses or network locations where NFTs and/or ownership data for NFTs may be sent for secure storage and later retrieval, use, and/or sale, as well as other actions or activities associated with NFT ownership. In this regard, blockchain platform 1102 may provide a network interface with other real or virtual devices, servers, and the like for different blockchains and/or NFTs. For example, minting of an NFT may be done at the platform level with all the required data stored at the level for blockchain platform 1102 accessible by blockchain platform 1102. As such, the inflow and movement of funds, currency (fiat or crypto), and the like may be seen in the wallets and transaction histories from blockchain records accessible to blockchain platform 1102.

When a user engages in a purchase, sale, or use of NFTs (or the ownership benefits provided by the NFTs), the user may access digital platform 1040 and/or one or more of the applications or websites associated with service applications 1032. This may require that the user perform an authentication and/or otherwise verify their identity and/or access to the corresponding digital wallet that holds the NFTs of the user. A unified login 1104 may provide a singular or limited authentication process and/or operation, which may be implemented as the access and/or authentication point for multiple different computing services, websites, applications, and/or other online platforms of transaction processor 1030. Unified login 1104 may provide an authentication process where a user may provide authentication credentials or other account, digital wallet, or user identification and verification information, and may be permitted access to and/or use of a digital wallet, corresponding NFTs, and the like. Unified login 1104 may provide a universal login to multiple different applications and/or websites, as well as their corresponding computing services and digital products for use, and may have an authentication process, login field, API and/or API integration, and the like that may be utilized by multiple applications and/or websites and through multiple different access points to digital platform 1040. As such, unified login 1104 may be consistent across all or a portion of service applications 1032 and/or digital platform 1040. When a user logs in to one of service applications 1032 and/or digital platform 1040, a user interface for the user's account and/or digital wallet may be displayed that may include information regarding available NFTs or NFTs of interest. One a user is logged in to their account and/or authenticated for access and use of their digital wallet, digital platform 1040 may also provide a process by which an authentication credential, proof of authentication, and the like may follow the user's journey or experience with digital platform 1040 including blockchain platform 1102, such as through cookie data, a tracking pixel, or device/session fingerprint, which prevents unnecessary reauthenticating the user and/or requiring the user to repeat a login process.

Unified login 1104 may provide the user with access to a digital wallet 1106, which may hold NFTs and/or ownership proofs of NFTs, and may be used for engaging in NFT trade, ownership usage of rights or privileges, and the like. Digital wallet 1106 may have a corresponding wallet address and may be used to send and/or receive digital assets using the address as a location on a network (e.g. the Internet) where the digital assets exchanged. Digital wallet 1106 for a user may correspond to an application or operations within another application to provide one or more user interfaces where a user may view payment instruments, different values or amounts of assets (e.g., fiat currency, cryptocurrency, NFTs, loyalty points, or other digital assets), and/or engage in financial transactions that may include the use of NFTs and other non-fungible digital assets. Further, digital wallet 1106 may provide other information and/or features for use with held digital assets, such as proofs of authenticity, valuations, links for NFTs to corresponding digital assets that may be located online or with another resource, information for NFT originality/authenticity and/or valuation, and the like. As such, the wallet level for digital wallet 1106 may reflect all or a portion of all actions and activities associated with NFT ownership, such as buying, store swapping, verifying ownership, etc.

Further as shown in system architecture 1100a, an NFT authentication platform 1108 perform, via digital wallet 1106, the authenticity checks and determinations for NFTs. For example, NFT authentication platform 1108 may be connected to blockchain platform 1102 in order to analyze and obtain information from one or more blockchains associated with an NFT, and utilize the information when determining an authenticity of an NFT. NFT authentication platform 1108 may further search for, determine, and/or aggregate additional information for NFT ownership, authenticity, or the like, such as known sales, owners, uses from public knowledge or events, and the like. Once an NFT has been added to digital wallet 1106 and/or authenticated by NFT authentication platform 1108, the user may utilize additional computing services of digital platform 1040, such as a checkout service 1110, a donate service 1112, and/or a reward/offer service 1114 (including use of a discounts platform 1116 for determination of available discounts). As such, NFT authentication platform 1108 may provide one or more processes by which NFTs can be verified and validated as part of a corresponding blockchain. For example, NFTs may be verified using a blockchain explorer as part of, or a computing service accessed and utilized by, NFT authentication platform 1108. AI models and predictions may be used to identify, determine, and/or assess potential risks with the NFTs. For example, a risk-based model utilized by NFT authentication platform 1108 may be used to look for patterns of any malicious or fraudulent practices and authenticity of NFTs when assessing their authenticity. In this regard, for each NFT, a corresponding smart contract may be found by the blockchain explorer and based on the blockchain for the NFT, which may be used to fraud assessment. Digital signatures for NFTs may also be utilized to provide proof of authenticity and/or verification. Further, if authenticity is verified and/or proven, the NFT may be presented as or with a badge or other icon on the user's profile and/or digital wallet that is used to prove that the NFT's authenticity has been assessed and determined to be valid by NFT authentication platform 1108.

In this regard, checkout service 1110 may provide a computing service and/or digital product where a user may access and/or utilize NFTs during an ecommerce experience, such as to build loyalty and/or receive offers for loyalty rewards during checkout by customers. Checkout service 1110 may enable users to utilize NFTs for payment during checkout, in a similar manner to how cryptocurrency may be used, but since each NFT may have a different value and is non-fungible, NFTs may be required to be converted to, or assess value in, another currency, whether fiat or cryptocurrency. Checkout service 1110 may integrate with different POS locations and devices, as well as online checkouts and digital shopping carts, to offer NFT usage and/or loyalty perks at checkout to users. This may also include showing or populating exclusive items for NFT owners, which may show up only for those owners and do not normally appear unless the NFT or other NFT related information is provided at checkout. Special incentives, including those determined by reward/offer service 1114 in conjunction with discounts platform 1116, may be provided at checkout based on NFT ownership. As such, the special incentives, such as coupons, may be created for NFT owners as a perk or benefit to increase NFT interest and sales, or may also be provided based on the NFT and its terms, minting conditions, and the like. Thus, checkout service 1110 may correspond to one of many NFT exclusive experiences provided to a user, which may further include early access to sale, exclusive products, exclusive content, and other benefits that will help to enhance customer loyalty and repeat purchase and sales.

Additionally, donate service 1112 and reward/offers service 1114 may provide similar perks, benefits, and/or privileges to the owners of NFTs. For example, donate service 1112 may provide a process to donate NFTs and/or proceeds from the sale of an NFT to a charity, as well as engage in purchase of NFTs for a charity or other cause having a fundraising effort. This may allow users to exchange ownership of NFTs with any cost for the exchange being donated to a charity of choice and/or charity corresponding to the fundraising effort. Thus, a portion of proceeds obtained from limited edition item or collectibles can be sent to the charity or other organization, which may use existing donation platforms with enhancements, auction sites, and the like. With discounts platform 1116, users may receive rewards, benefits, discounts, and offers of items or services based on their NFTs in their collection. For example, different minting events, ownership groups, and collectives may offer NFT owners with certain privileges by virtue of owning the corresponding NFT, or providing another service with regard to the NFT, such as by collecting several in a collection or across related collections and the like. Reward/offer service 1114 may provide such rewards and benefits during checkout, but a user may also access the service to search NFTs, view the user's available NFTs and corresponding rewards, and/or inquire about the availability of benefits and/or rewards.

Referring now to FIG. 11B, in system architecture 1100b, different layers and components of a system are shown for interacting with the computing services and digital products of NFT lifecycle management 1041 for digital platform 1040. With NFTs, minting and handling an NFT over the ownership lifecycle until a coin is sold conventionally requires a login to multiple applications and verification processes that occur across multiple sources and/or entities associated with those applications. Instead, as shown in system architecture 1100b, a consumer wallet identity 1122 may be provided to interact with the other components of digital platform 1040 for NFT lifecycle management without the multiple logins and authentications.

In this regard, consumer wallet identity 1122, such as an identity token or other identifier or credential associated with digital wallet 1106, may receive data from and permit access to multiple different computing services. As upstream consumer crypto marketplace/commerce 1124 may provide data for NFTs that the user owns or is interested in purchasing, and allows the user to buy and sell NFTs, as well as trade, donate, or identify ownership perks that may allow for purchase or obtaining of other NFTs (e.g., from minting events) based on the NFTs owned by the user. NFT service tokens 1126 may be generated by a token generation and verification process 1128, which may include tokens associated with the various computing services and digital products and allow for availing those services, as well as external or third-party services, in order to obtain and/or provide the user with an NFT ownership benefit, right, or privilege. NFT service tokens 1126 may be generated by token generation and verification process 1128 based on the NFTs of the user, as well as information from merchants on platform 1130, which may provide additional services for NFT owners, such as checkout and payment with NFTs, loyalty services, discounts and memberships, and the like.

Consumer wallet identity 1122 may share a link 1132 to a public crypto wallet identity 1136 for purposes of public NFT usage on external or public exchanges, marketplaces, owner services, and the like. In this regard, public crypto wallet identity 1136 may provide a layer of security by acting as the public wallet and only storing a limited amount of liquidity for currency or active NFTs for marketplaces, such as those NFTs that may be sold or purchased in the near future (as designated by a user) and/or have been placed on a marketplace for purchase/sale/trade. Public crypto wallet identity 1136 enables the user to interact with public NFT marketplaces 1134, as well as blockchain and crypto wallets that may be public and/or not part of the internal system of the transaction processor providing the NFT services.

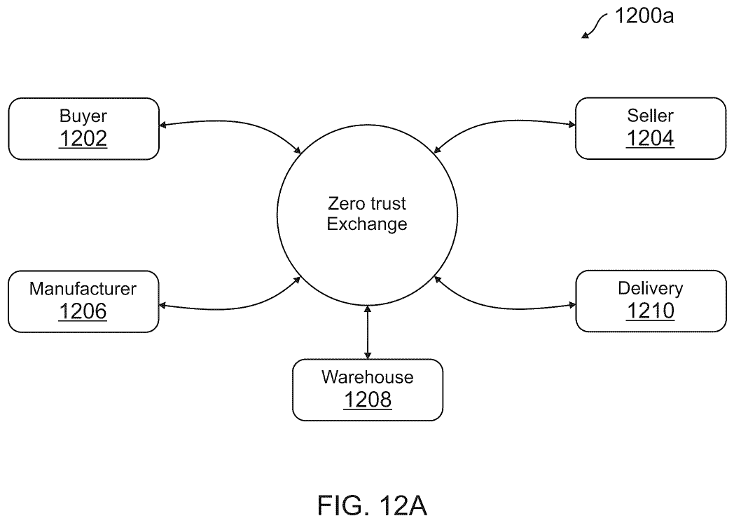

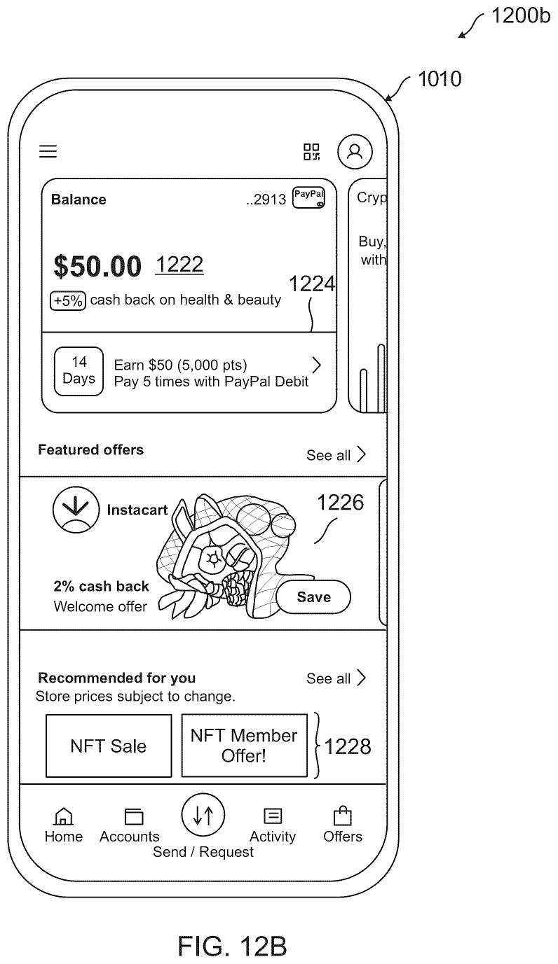

FIGS. 12A and 12B illustrates exemplary diagrams 1200a and 1200b associated with NFT lifecycle management of NFTs using a unified digital platform for inclusion of different NFT services used during lifecycles of NFT ownership, according to an embodiment. Diagram 1200a represents a zero-trust environment for NFT ownership services and corresponding NFTs in a digital wallet managed by transaction processor 1030. Diagram 1200b shows an exemplary user interface or screenshot of a user interface on a mobile device that may provide NFT services during checkout and/or in a digital wallet of a user. The processes performed to provide NFT ownership services in diagrams 1200a and 1200b may be performed by digital platform 1040 of transaction processor 1030 using the components shown in system 1000 and system architectures 1100a and 1100b.

In diagram 1200a, a zero-trust environment is provided where none of the components “trust” each other (e.g., requiring an authentication or verification to allow certain data to be communication between the components). Conventionally with separate NFT systems, this type of security may occur with separate computing platforms, applications, and systems. However, with use of a zero-trust environment within transaction processor 1030, authentication 1048, such as unified login 1104 for multiple computing services that may be tracked with a user, may provide a mechanism for trust between different system components. For example, using the trusted authentication through unified login 1104 that is linked and/or provided separately but utilizing the same authentication system and/or processes, a login at one computing service may provide a login and/or trusted authentication with other computing services, allowing for the user to avail those computing services without additional logins and authentications. Further, NFTs may provide a value store due to their unique non-fungible and digital characteristics for interactions and transactions in a zero-trust system, which may include order, shipping and delivery of items, escrow, and the like.

Referring now to FIG. 12B, in diagram 1200b, client device 1010, such as a mobile smart phone, is shown displaying a wallet interface 1222 where a user may view their payment and asset information including financial instruments, cryptocurrency, and/or NFTs. Wallet interface 1222 may provide a user with primary balance information 1224 regarding a current balance and perk for use of a financial instrument tied to that balance. The user may scroll through and view other balances and/or financial instruments in wallet interface 1222 or may select primary balance information 1224 to process a transaction, send a payment, request a payment, or the like. Under offers 1226, a user may view different offers for which they are eligible, which may include standard discounts from financial instruments, purchases, or loyalty, but may also include NFT offers 1228. NFT offers 1228 may be populated based on the user's NFT ownership and/or interest in particular NFTs or NFT collections. The user may view NFT offers 1228 to be linked to the corresponding NFT on a marketplace, such as one provided by trading service 1043 of digital platform 1040, in order to purchase the NFT or otherwise interact with the NFT for browsing and/or further inquiries (e.g., bidding, checking authenticity, etc.).

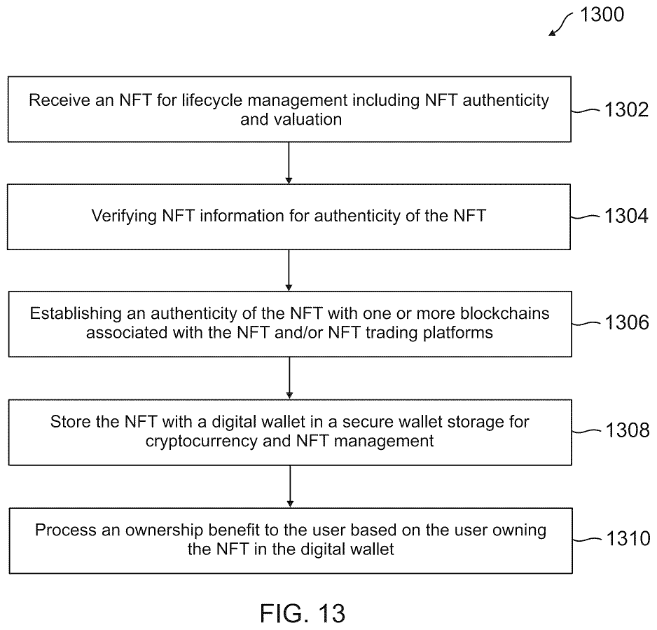

FIG. 13 illustrates a flowchart 1300 for operations or steps performed by a unified digital platform for lifecycle management of NFTs, according to an embodiment. Flowchart 1300 may be performed by digital platform 1040 using digital wallets holding NFTs or digital key, certificates, or the like that provide ownership over NFTs. In this regard, digital platform 1040 may provide NFT lifecycle management 1041 to client device 1010, which may be used during the management of NFTs over the lifecycle of their ownership by a user. Note that one or more steps, processes, and methods described herein of flowchart 1300 may be omitted, performed in a different sequence, or combined as desired or appropriate.

At step 1302 of flowchart 1300, an NFT is received with a request for an NFT service, such as NFT authenticity and valuation, at a wallet address and/or for inclusion in a corresponding digital wallet of a user, where the digital wallet, NFT, or the like may be managed by and/or serviced by digital platform 1040 using NFT lifecycle management 1041. An NFT may be received through a request to deposit the NFT to a digital wallet from another wallet address, minting event that creates the NFT, and/or digital exchange that trades and/or provides escrow services for NFT buying, selling, and/or trading. Furthermore, the request may be initiated based on a number of factors or events, such as signup for an account, onboarding, transfer to an existing account, purchase from an exchange or another user, ownership right for a created NFT (e.g., an owner for an initial minting event), and the like. On receipt of the NFT, the user may be required to be authenticated using authentication 1048 for access to the NFT, and the NFT may further be verified for authenticity. A verification and authorization may be required prior to certain activities being permitted for NFT usage.

At step 1304, NFT information for authenticity of the NFT is verified. A blockchain and blockchain records associated with the NFT may be looked up and/or retrieved/accessed by authenticity service 1042, which may show an NFT minting or creation event, initial ownership or possession of the NFT, any exchanges or transfers of ownership, and/or any lifetime events that may affect NFT ownership, such as partial or percentage stake or ownership, right to utilize or licensing agreements, and the like. As such, authenticity service 1042 may process information affecting the NFTs ownership title and past owners, which may be determined from blockchain records and any marketplaces or exchanges on which the NFT has been exchanged, put up for sale or transfer, or requested in another sale or transfer. The information may be processed using one or more AI models, such as a machine learning (ML) or neural network (NN) model trained to assess ownership information, for determination of whether the NFT is the actual and true NFT (e.g., not a fake of an original NFT) and is what the NFT purports to be. This may include scoring the NFT for validity or originality and providing a score or the like that may be judged directly or may be compared to thresholds for determination of validity and/or authenticity. A badge, certificate, or other identified of originality may be provided, which may have different levels or descriptors based on the score for originality and/or authenticity.

At step 1306, an authenticity of the NFT is established with one or more blockchains associated with the NFT and/or NFT trading platforms. Once the authenticity has been determined, trading service 1043 may establish the NFT as authentic and may enable the user to utilize ownership rights and privileges, such as the right to sell or license the NFT, a right to exclude others from access and/or use, and the like. When establishing the authenticity of the NFT with trading service 1043, such as on or with a digital marketplace or exchange where NFTs, cryptocurrency, and/or other digital assets and items may be exchanged, the NFT may be marked or provided an icon, badge, certificate, or the like, including a signed digital certificate, that denotes and/or proves the authenticity, originality, or verification of the NFT.

Further, the authenticity of the NFT may be established by recording the proof, or a direction or link to the proof, of authenticity of the NFT on a corresponding blockchain for the NFT and/or used to record authenticity proofs of NFTs for a digital marketplace, trading service 1043, or the like. In this regard, a block or other distributed transaction record may be generated or written to by authenticity service 1042, which may then be recorded by distributing the block or record over the distributed nodes, machines, or devices of the blockchain and that make up the distributed network for blockchain recordation, persistence of blocks, and immutability. Thus, authenticity service 1042 may ensure that the NFT is identified with a corresponding authenticity, or lack thereof, as well as any level, measure of certainty, or the like based on the scored output of the AI model utilized to prove the NFTs authenticity at step 404. The authenticity may be established with trading service 1043 for purposes of valuation on a marketplace and/or marketability or resale value of the NFT to other users. Further, trading service 1043 may provide one or more processes by which a valuation of the NFT may also be determined and associated with the NFT, including recording the valuation to a blockchain associated with the NFT and/or the authenticity determined for the NFT. However, since the valuation may change over time, the valuation may only be recorded in blockchain records or blocks when bought/sold instead of merely being evaluated without a tangible exchange of value for the NFT, although preferences for such may be established by the owner and/or minting event creating the NFT.

At step 1308, the NFT is stored with a digital wallet in a secure wallet storage for cryptocurrency and NFT management. The NFT is stored by a digital wallet of the user on or with digital platform 1040 by storing a reference, an encryption key (e.g., a private key, similar to private cryptocurrency keys that provide an ownership right to a corresponding amount of the cryptocurrency through the encryption key signing protocol), a digital certificate or a signature that confers ownership of the NFT, or even an identifier, address, or link to a block or record on a blockchain that records a user's ownership (or the user's digital wallet, wallet address, online identity, etc.) of the NFT. As such, a digital wallet with digital platform 1040 may have access to the NFT for purposes of exchanging ownership of the NFT, but may also provide additional benefits, computing services, and digital products that may be utilized during the lifecycle of NFT ownership. For example, once an NFT has been transferred to and/or stored with a digital wallet of the user provided and/or managed by transaction processor 1030, digital platform 1040 may provide the computing service and digital products of NFT lifecycle management 1041 to the user and make those services and products available during the course of NFT ownership. As such, a user may login to a single unified hub or platform where the user may access multiple different computing services and/or digital products for NFT owners, which may be done through a single application or suite of applications or single website or domain of interconnected or interrelated websites. This may also simplify and/or reduce the number of authentications, re-authentications by the user, and/or multiple logins, login credentials or authentication credentials, signups and submissions of personally identifiable information (PII) or know your customer (KYC) information, which may minimize risk and/or private or privacy-controlled data from being leaked or misappropriated.

At step 1310, an ownership benefit is provided to the user based on the user owning the NFT in the digital wallet. The ownership benefit may be provided by one or more of the computing services and/or digital products provided by NFT lifecycle management 1041. In this regard, a user may request, or NFT lifecycle management 1041 may determine, an ownership right, privilege, or benefit conferred to the owners of certain NFTs. This may be done through a lookup and determination of the minting event and users or entity that minted the NFT, through the NFTs blockchain and corresponding digital records, and/or through an online search or available documentation for ownership information of the NFT itself and/or for multiple NFTs. Where a user may request access to an ownership benefit, NFT lifecycle management 1041 may verify that such benefit is available, and, if so, may execute one or more operations and/or tasks to provide the benefit to the user, such as by redirecting the user to the benefit and/or information on utilizing the benefit from another online website or resource. However, where one or more search operations, AI models or intelligent automations, or the like are used to determine the ownership benefit, NFT lifecycle management 1041 may have previously called the APIs and other available interfaces so that an integration with and/or data for the ownership benefit may be easily provided to the user via digital platform 1040.

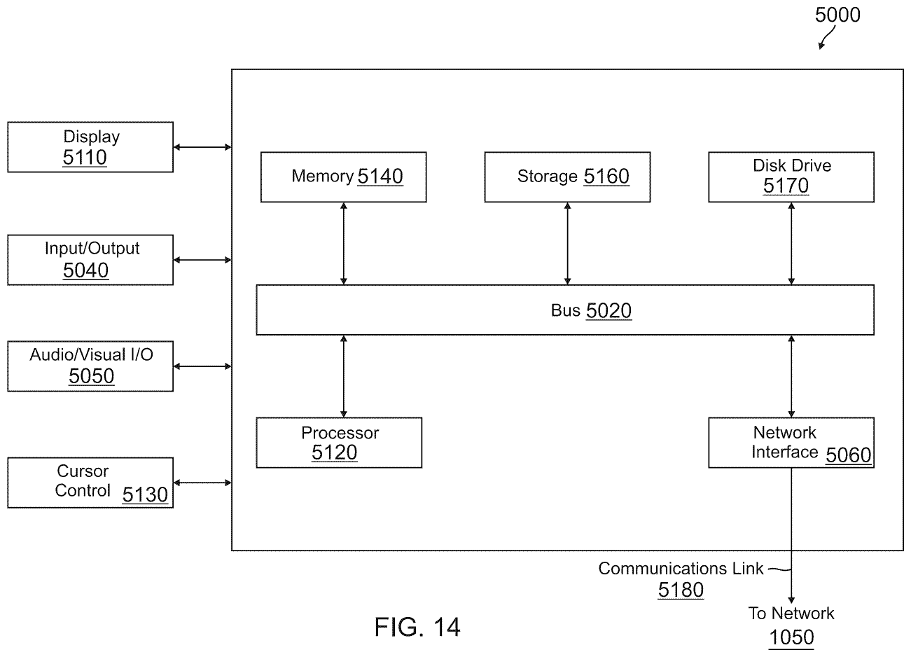

FIG. 14 is a block diagram of a computer system 5000 suitable for implementing one or more components in FIG. 10, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 5000 in a manner as follows.

Computer system 5000 includes a bus 5020 or other communication mechanism for communicating information data, signals, and information between various components of computer system 5000. Components include an input/output (I/O) component 5040 that processes a user action, such as selecting keys from a keypad/keyboard, selecting one or more buttons, image, or links, and/or moving one or more images, etc., and sends a corresponding signal to bus 5020. I/O component 5040 may also include an output component, such as a display 5110 and a cursor control 5130 (such as a keyboard, keypad, mouse, etc.). An optional audio input/output component 5050 may also be included to allow a user to use voice for inputting information by converting audio signals. Audio I/O component 5050 may allow the user to hear audio. A transceiver or network interface 5060 transmits and receives signals between computer system 5000 and other devices, such as another communication device, service device, or a service provider server via a network, such as network 1050 of FIG. 10. In one embodiment, the transmission is wireless, although other transmission mediums and methods may also be suitable. One or more processors 5120, which can be a micro-controller, digital signal processor (DSP), or other processing component, processes these various signals, such as for display on computer system 5000 or transmission to other devices via a communication link 5180. Processor(s) 5120 may also control transmission of information, such as cookies or IP addresses, to other devices.

Components of computer system 5000 also include a system memory component 5140 (e.g., RAM), a static storage component 5160 (e.g., ROM), and/or a disk drive 5170. Computer system 5000 performs specific operations by processor(s) 5120 and other components by executing one or more sequences of instructions contained in system memory component 5140. Logic may be encoded in a computer readable medium, which may refer to any medium that participates in providing instructions to processor(s) 5120 for execution. Such a medium may take many forms, including but not limited to, non-volatile media, volatile media, and transmission media. In various embodiments, non-volatile media includes optical or magnetic disks, volatile media includes dynamic memory, such as system memory component 5140, and transmission media includes coaxial cables, copper wire, and fiber optics, including wires that comprise bus 5020. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 5000. In various other embodiments of the present disclosure, a plurality of computer systems 5000 coupled by communication link 5180 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A method comprising:
receiving, at a digital platform of a transaction processor, a checkout for a transaction indicating a payment to be provided by a user using a value associated with a first non-fungible token (NFT);
determining login information for the user, wherein the login information is for a login to an account with an entity associated with the transaction processor that is verified with a plurality of computing services for the digital platform of the transaction processor that manages one or more NFTs of the user, and wherein the login unifies access to the plurality of computing services for the account in a single authentication with the digital platform;
authenticating the user for the login to the account based on the login information, wherein the login is managed using an authentication layer of the digital platform across the plurality of computing services for the checkout;
accessing a digital wallet of the user that stores one or more encryption keys associated with the one or more NFTs of the user;
establishing an authenticity of the first NFT from the one or more NFTs of the user using a first computing service of the plurality of computing services and lifecycle information of the NFT with at least the digital platform;
determining the value of the first NFT using a second computing service of the plurality of computing services and based on the authenticity and a digital marketplace for NFT exchanges that is associated with the second computing service;
providing the value to the user, wherein the value is provided with an option to initiate a sale of the first NFT using the value via at least the second computing service; and
writing the value of the first NFT to a block of a blockchain associated with the first NFT.

2. The method of claim 1, wherein the lifecycle information comprises at least one of an owner history of the first NFT, information associated with a minting event that created the first NFT, or a digital asset corresponding to the first NFT, and wherein the lifecycle information enables a verification of an origin of the first NFT.

3. The method of claim 2, further comprising:
providing the user with a membership for NFT ownership based on the first NFT in the digital wallet of the user and a third service that monitors NFT rewards, wherein the membership includes a loyalty program with at least the entity for usage of the first NFT.

4. The method of claim 1, wherein the determining the login information comprises one of requesting and receiving the login information for the checkout or identifying an identifier associated with the login information that was provided for the checkout, and wherein the user is automatically authenticated after the login using the login information for an additional processing request for one of the plurality of computing services during a session of an application being used for the checkout on a mobile device of the user using the authentication layer without requesting the login information an additional time.

5. The method of claim 1, further comprising:
providing one or more application programming interfaces (APIs) to interact with one or more application processes of a mobile application of a mobile device of the user that utilizes the plurality of computing services of the digital platform, and wherein the plurality of computing services are accessible via the mobile application using the one or more APIs for management of the first NFT and one or more second NFTs without a separate mobile application or multiple logins during an application session.

6. The method of claim 1, further comprising:
determining that the value was not used for the transaction;
retaining an encryption key associated with the first NFT in the digital wallet of the user; and
identifying, with the block written to the blockchain, that the first NFT was not sold to obtain at least the value.

7. The method of claim 1, further comprising:
determining that the value has been used for the transaction; and
processing the transaction using based on information associated with the checkout and the digital wallet.

8. The method of claim 7, further comprising:
providing a balance of the value for access by the digital wallet using a third computing service of the plurality of computing services;
obtaining an encryption key of the one or more encryption keys for the first NFT from the digital wallet; and
offering the first NFT for sale on the digital marketplace using at least the second computing service,
wherein the processing the transaction comprises processing the payment for the checkout based at least on the value provided.

9. The method of claim 1, further comprising:
connecting the user to at least one of a donate platform or a reward platform in a mobile application on a mobile device of the user during the checkout; and
providing, in the mobile application, a donation campaign or a reward incentive associated with at least one of the checkout or the one or more NFTs held by the digital wallet.

10-20. (canceled)

21. A system comprising:
a non-transitory memory; and
one or more hardware processors coupled to the non-transitory memory and configured to execute instructions to cause the system to:
receive, at a digital platform of a transaction processor, a checkout for a transaction indicating a payment to be provided by a user using a value associated with a first non-fungible token (NFT);
determine login information for the user, wherein the login information is for a login to an account with an entity associated with the transaction processor that is verified with a plurality of computing services for the digital platform of the transaction processor that manages one or more NFTs of the user, and wherein the login unifies access to the plurality of computing services for the account in a single authentication with the digital platform;
authenticate the user for the login to the account based on the login information, wherein the login is managed using an authentication layer of the digital platform across the plurality of computing services for the checkout;
access a digital wallet of the user that stores one or more encryption keys associated with the one or more NFTs of the user;
establish an authenticity of the first NFT from the one or more NFTs of the user using a first computing service of the plurality of computing services and lifecycle information of the NFT with at least the digital platform;
determine the value of the first NFT using a second computing service of the plurality of computing services and based on the authenticity and a digital marketplace for NFT exchanges that is associated with the second computing service;
provide the value to the user, wherein the value is provided with an option to initiate a sale of the first NFT using the value via at least the second computing service; and
write the value of the first NFT to a block of a blockchain associated with the first NFT.

22. The method of claim 21, wherein the lifecycle information comprises at least one of an owner history of the first NFT, information associated with a minting event that created the first NFT, or a digital asset corresponding to the first NFT, and wherein the lifecycle information enables a verification of an origin of the first NFT.

23. The method of claim 22, wherein executing the instructions further causes the system to:
provide the user with a membership for NFT ownership based on the first NFT in the digital wallet of the user and a third service that monitors NFT rewards, wherein the membership includes a loyalty program with at least the entity for usage of the first NFT.

24. The method of claim 21, wherein the determining the login information comprises one of requesting and receiving the login information for the checkout or identifying an identifier associated with the login information that was provided for the checkout, and wherein the user is automatically authenticated after the login using the login information for an additional processing request for one of the plurality of computing services during a session of an application being used for the checkout on a mobile device of the user using the authentication layer without requesting the login information an additional time.

25. The method of claim 21, wherein executing the instructions further causes the system to:
provide one or more application programming interfaces (APIs) to interact with one or more application processes of a mobile application of a mobile device of the user that utilizes the plurality of computing services of the digital platform, and wherein the plurality of computing services are accessible via the mobile application using the one or more APIs for management of the first NFT and one or more second NFTs without a separate mobile application or multiple logins during an application session.

26. The method of claim 21, wherein executing the instructions further causes the system to:
determine that the value was not used for the transaction;
retain an encryption key associated with the first NFT in the digital wallet of the user; and
identify, with the block written to the blockchain, that the first NFT was not sold to obtain at least the value.

27. The method of claim 21, wherein executing the instructions further causes the system to:
determine that the value has been used for the transaction; and
process the transaction using based on information associated with the checkout and the digital wallet.

28. The method of claim 27, wherein executing the instructions further causes the system to:
provide a balance of the value for access by the digital wallet using a third computing service of the plurality of computing services;
obtain an encryption key of the one or more encryption keys for the first NFT from the digital wallet; and
offer the first NFT for sale on the digital marketplace using at least the second computing service,
wherein the processing the transaction comprises processing the payment for the checkout based at least on the value provided.

29. The method of claim 21, wherein executing the instructions further causes the system to:
connect the user to at least one of a donate platform or a reward platform in a mobile application on a mobile device of the user during the checkout; and
provide, in the mobile application, a donation campaign or a reward incentive associated with at least one of the checkout or the one or more NFTs held by the digital wallet.

30. A non-transitory machine-readable medium having stored thereon machine-readable instructions executable to cause a machine to perform operations comprising:
receiving, at a digital platform of a transaction processor, a checkout for a transaction indicating a payment to be provided by a user using a value associated with a first non-fungible token (NFT);
determining login information for the user, wherein the login information is for a login to an account with an entity associated with the transaction processor that is verified with a plurality of computing services for the digital platform of the transaction processor that manages one or more NFTs of the user, and wherein the login unifies access to the plurality of computing services for the account in a single authentication with the digital platform;
authenticating the user for the login to the account based on the login information, wherein the login is managed using an authentication layer of the digital platform across the plurality of computing services for the checkout;
accessing a digital wallet of the user that stores one or more encryption keys associated with the one or more NFTs of the user;
establishing an authenticity of the first NFT from the one or more NFTs of the user using a first computing service of the plurality of computing services and lifecycle information of the NFT with at least the digital platform;
determining the value of the first NFT using a second computing service of the plurality of computing services and based on the authenticity and a digital marketplace for NFT exchanges that is associated with the second computing service;
providing the value to the user, wherein the value is provided with an option to initiate a sale of the first NFT using the value via at least the second computing service; and
writing the value of the first NFT to a block of a blockchain associated with the first NFT.

31. The non-transitory machine-readable medium of claim 30, wherein the lifecycle information comprises at least one of an owner history of the first NFT, information associated with a minting event that created the first NFT, or a digital asset corresponding to the first NFT, and wherein the lifecycle information enables a verification of an origin of the first NFT.
